(19) United States
(12) Patent Application Publication
(10) Pub. No.: US 2010/0312620 A1
(43) Pub. Date: Dec. 9, 2010

(54) METHODS, APPARATUS, SYSTEMS, COMPUTER PROGRAM PRODUCT AND MEDIUM FOR USE IN ASSOCIATION WITH RELATIONSHIP REWARDS PROGRAMS

(76) Inventors: Brigette White, Cortland Manor, NY (US); Andrea Gilman, Chappaqua, NY (US); Sara E. Fiebiger, Ellisville, MO (US)

Correspondence Address: BUCKLEY, MASCHOFF & TALWALKAR LLC, 50 LOCUST AVENUE, NEW CANAAN, CT, 06840, US

(21) Appl. No.: 12/601,452

(22) PCT Filed: May 23, 2008
(86) PCT No.: PCT/US08/64632

§ 371 Date: Aug. 20, 2010

(30) Foreign Application Priority Data
May 23, 2007 (US) 11/752412

(51) Int. Cl. G06Q 30/00

(52) U.S. Cl. 705/14.1; 705/1.1

(57) ABSTRACT

Methods, apparatus, systems, computer program product and medium for use in association with relationship rewards programs are provided.

### FIELD OF THE INVENTION

The present disclosure relates to customer relationships and incentive programs. In particular, some embodiments relate to methods, apparatus, systems, computer program products and/or mediums for use in incentivizing and rewarding customer relationships with providers.

### BACKGROUND

Many merchants offer incentives to encourage customer actions. For example, some financial institutions issue credit cards that earn airline miles based on the amount of purchases made by a cardholder using the card. The airline miles can be redeemed for airline travel. Other merchants have reward programs that award customers points based on purchases made at the store. The points may be redeemed for merchandise or cash. Other merchants have reward programs that award customers cash back when the customers make certain purchases. Each of these reward programs motivate customer behavior. Unfortunately, however, existing reward programs do not reward customer behavior across different relationships or with different merchants or providers.

### BRIEF DESCRIPTION OF THE DRAWINGS

The accompanying drawings, which are incorporated in and form a part of the specification, illustrate some embodiments of the present disclosure, and together with the descriptions serve to explain some of the principles of the disclosure.

FIG. 1A is a block diagram depicting customer relationships with providers in a reward system in accordance with some embodiments.

FIG. 1B is a block diagram depicting one embodiment of a reward system in accordance with some embodiments.

FIG. 2 is a flowchart of a method in accordance with some embodiments.

FIG. 3 is a flowchart of a method in accordance with some embodiments.

FIG. 4 is a flowchart of a method in accordance with some embodiments.

FIG. 5 is a flowchart of a method in accordance with some embodiments.

FIG. 6 is a diagram of a data format in accordance with some embodiments.

FIG. 7 is a diagram of a data format in accordance with some embodiments.

FIG. 8 is a diagram of a data format in accordance with some embodiments.

FIG. 9 is a diagram of a data format in accordance with some embodiments.

FIG. 10 is a diagrammatic representation of a database, according to some embodiments.

FIG. 11 is a flowchart of a method in accordance with some embodiments.

FIG. 12 is a flowchart of a method in accordance with some embodiments.

FIG. 13 is a functional block diagram of a processing system in accordance with some embodiments.

FIG. 14 is a functional block diagram of one embodiment of a portion of the processing system of FIG. 13.

FIG. 15 is a flowchart of a method in accordance with some embodiments.

FIG. 16 is a flowchart of a method in accordance with some embodiments.

FIG. 17 is a flowchart of a method in accordance with some embodiments.

### DETAILED DESCRIPTION

Applicants have determined that merchants or other providers can increase the number of business relationships with a customer by providing a rewards program that allows the customer to earn rewards across different different relationships and across different relationships with different merchants or providers. Some embodiments disclosed herein may encourage and/or provide the capability for such. Moreover, in some embodiments, rewards earned across multiple relationships may be aggregated. In some embodiments, one or more of the above capabilities may have the advantage of increasing profit of one or more providers.

For example, a financial institution may enjoy a more profitable relationship with a customer if the customer has multiple relationships with the financial institution, such as a checking account, a savings account, a credit card account, and a loan account than if the customer only had a checking account with the financial institution. Notably, most customers have an average of 1.5 relationships with their financial institution, when three or four relationships may be needed for the financial institution to enjoy a profitable relationship.

In some embodiments, one or more incentive programs funded by a merchant or merchants may be implemented, at least in part, using a payment processing network, such as the system administered by MasterCard International Incorporated, the assignee hereof. In some embodiments, processing and/or administrative economies may be realized by using a previously existing payment processing network. Pursuant to some embodiments, not all (or even any) transactions or relationships need be processed using the payment processing network—some providers may report, transmit, or otherwise upload transactions to a reward administrator for participation in the relationship reward program of the present invention. For example, a financial institution (the “provider”) may offer its customers an online banking service, and may wish to reward or incentivize use of the service. The financial institution may utilize features of the present invention to reward use of the service by uploading or submitting a file containing information about registered customers and the number of times each customer has used the online banking system. That is, the financial institution is rewarding customers for a particular relationship and incentivized activity (use of a service). Those skilled in the art, upon reading this disclosure, will recognize that other relationships and activities may also be rewarded using features of the present invention.

A number of terms will be used herein to describe features of some embodiments. For example, as used herein, the term “customer” is used to refer to an individual or entity having a relationship with a provider. As used herein, the term “provider” is used to refer to a merchant, financial institution, or other entity that wishes to motivate customers to establish, maintain, and utilize relationships with the provider. As used herein, the term “relationship” is used to refer to a business or other relationship between a provider and a customer. As illustrative, but not comprehensive, examples, relationships may include account relationships (such as a financial account held by a customer with a bank) and other transaction relationships (such as an online banking service offered by a bank and utilized by a customer). In general, pursuant to some embodiments, features of the present invention may be used to reward any “relationship” between a customer and a provider that the provider wishes to encourage, reward or motivate using incentives or rewards. As used herein, the term “transaction” is generally referred to as an incentivized action or activity. For example, in the context of a payment card account, each use of the payment card may be a “transaction”. A transaction is not limited to a traditional financial transaction, instead it refers to any incentivized action or activity.

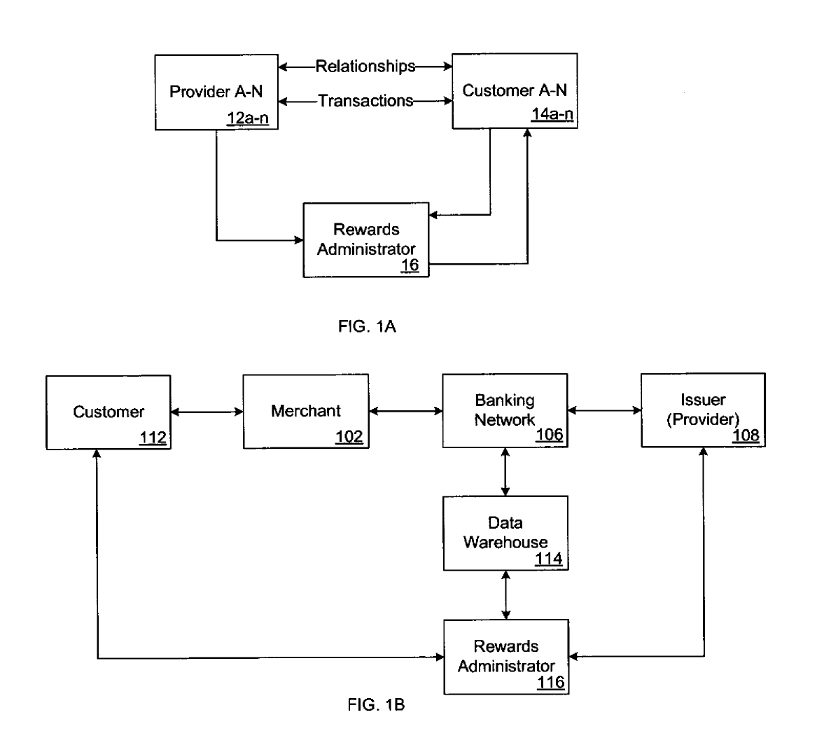

FIG. 1A is a block diagram illustrating a relationship rewards system pursuant to some embodiments. As shown, a number of providers 12a-n may participate in a relationship rewards system pursuant to the present invention. Each provider 12 may have one or more relationships with one or more customers 14a-n. Each of those customers 14 may engage in one or more transactions associated with each relationship with a provider 12. Embodiments of the present invention allow rewards or other incentives to be awarded to customers based on some or all of those transactions. As will be described further below, eligible providers 12 and customers 14 register or are registered with a rewards administrator 16 so that qualifying transactions may be tracked and so that those qualifying transactions can be rewarded. As discussed above, providers may include any of a number of different merchants or entities that wish to reward their customers. To illustrate features of embodiments, a particular type of provider will be described in more detail—a financial institution such as a credit-card issuing bank. Further, particular types of relationships will be described in more detail to illustrate features of some embodiments—a banking relationship involving a payment card issued by the financial institution to a customer. Some embodiments of the present invention allow the tracking and award of rewards or incentives to customer by using features of existing banking networks to track transactions associated with customers and providers.

Referring now to FIG. 1B, a further block diagram is shown which illustrates an embodiment of the present invention in which the rewards administrator device 116 is in communication with a banking network 106 such as the banking network operated by MasterCard International Incorporated, the assignee of the present application. In describing embodiments such as the embodiment depicted in FIG. 1B, the “relationship” between a customer 112 and an issuer 108 (the “provider”) is an “account” relationship where the customer 112 holds a financial account with the issuer 108 and uses the financial account to conduct purchase transactions. For the purpose of illustrating features of some embodiments, features will be described by discussing payment transactions using a payment card, such as a credit or debit card.

As used herein, a payment card may comprise any type of payment card. In some embodiments, a payment card may comprise a private label credit card account associated with a retail business, co-brand credit card accounts associated with a retail business, dual cards associated with a retail business, and/or any other type(s) of payment card accounts, stored value cards, debit cards, or the like, and/or other types of payment cards. Those skilled in the art will recognize that a payment card pursuant to some embodiments may be any of a number of different types of embodiments, including, for example, magnetic stripe cards, radio frequency identification (“RFID”) cards, contact or contactless smart cards, virtual credit or debit cards, etc.

Referring to FIG. 1B, in some embodiments, processing payment transactions and determining rewards may involve a plurality of entities 102-112. The first entity 102 may be a merchant that accepts payment cards as payment for goods and/or services. A merchant may comprise any type of merchant. In some embodiments, a merchant comprises a provider of good(s) and/or service(s) including but not limited to a retail business, a restaurant, a hotel, a bank or other type of financial institution, an airline or other type of transportation provider and/or a telephone, television, Internet or other type of communication provider. Each merchant, in a payment card transaction, typically processes payments through a relationship with an “acquirer” (not shown). An acquirer may be an entity that has agreed to assist the merchant 102 in processing of transactions that involve a payment card. The term “acquirer” is widely used in the payment processing field, and refers to financial institutions or other financial systems that have agreement with merchants to receive and forward purchase transaction authorizations and settlement requests on behalf of the merchants. As used herein a “financial institution” may comprise, but is not limited to, a finance company and/or a bank. In that regard, in some embodiments, the acquirer may be is a bank. The term “acquirer” also refers to processing agents that act on behalf of such financial institutions or systems.

The merchant 102 is in communication (typically through an acquirer) with one or more banking networks 106 such as the banking networks operated by MasterCard International Incorporated. Banking networks 106 operate to facilitate the authorization, settlement and clearing of financial transactions. In some embodiments, banking network 106 is in communication with one or more issuers 108. In the embodiment depicted, an issuer 108 is a financial institution which has an account relationship with customer 112. Banking network 108 is in communication with issuer 108 to facilitate the authorization, settlement and clearing of transactions involving a payment card issued to customer 112.

In some embodiments, processing of a payment card transaction may include three parts: authorization, clearance and settlement. In authorization, the merchant 102 may send a message to an acquirer. The message may include data indicative of the transaction, sometimes referred to as transaction data. In some embodiments, transaction data may include data indicative of a purchase price, sometimes referred to herein as purchase price data, and data indicative of the payment account, sometimes referred to herein as payment account data. The acquirer may send a message, which may include the transaction data, to the banking network 106, which may in turn determine the issuer 108 of the payment card. Thereafter, the banking network 106 may send a message, which may include the transaction data, to the issuer 108 of the payment card, which may in turn determine whether to approve the transaction. Thereafter, the issuer 108 may send a message back to the banking network 106. The message may include data indicative of the determination, sometimes referred to herein as an authorization response. The banking network 106 may send a message, which may include the authorization response, back to the acquirer, which may in turn supply the data to the merchant 102. If the authorization response indicates that the transaction is approved, the customer 112 may receive the good(s) and/or service(s) purchased from the merchant.

Pursuant to some embodiments, after a payment transaction is completed, the banking network 106 may send one or more portions of the transaction data to a data warehouse. In some embodiments, the transaction data may be sent to the data warehouse as soon as the transaction is complete. In some embodiments, the transaction data is sent to the data warehouse in batches. For example, if the clearance part and/or the settlement part of the transaction are performed as part of a batch, the transaction data may be sent to the data warehouse after the last batch of each day.

In some embodiments, one or more portions of the transaction data may be supplied to a rewards administrator 116 in communication with the banking network 106 and/or the data warehouse 114. The rewards administrator 116 processes transaction data to identify transactions that qualify for rewards and/or credit rewards to accounts of customers who participate in rewards programs. In some embodiments, the functionality performed by reward administrator 116 may be performed within the banking network 106.

In some embodiments, rewards administrator 116 may determine transactions that qualify for rewards based at least in part on the transaction data and on data that defines the one or more rewards programs. The latter may include criteria for use in determining whether a transaction qualifies for a reward, and if so, the type and/or amount of the reward. In some embodiments, the rewards administrator 116 may receive the transaction data directly from the banking network 106. In some embodiments, the rewards administrator 116 may receive the transaction data from the data warehouse 114.

As stated above, some embodiments may allow a customer to earn rewards or other incentives based on actions involving one or more different accounts or relationships with a provider. Further, some embodiments allow a customer to earn rewards or other incentives based on actions involving one or more different accounts or relationships with one or more different providers.

In some embodiments, a unique identifier, sometimes referred to herein as a unique customer identifier, may be assigned to each customer participating in the relationship rewards system of the present invention. If a customer has more than one account or relationship with a provider, each of such accounts or relationships of the customer may be identified by an account identifier linked to the unique customer identifier assigned to the customer. Further, the unique customer identifier may be used to identify customer accounts or relationships with one or more different providers. In this manner, embodiments allow customers to earn rewards for actions or activities (such as, in some examples, payment card purchase transactions) with one or more different providers. The rewards administrator 116 uses the unique identifier to track, monitor, and administer such actions or activities across different accounts or relationships with one or more providers. In this manner, customers enjoy an ability to earn rewards or incentives for multiple relationships and activities, increasing their ability to earn rewards. Further, providers (such as financial institutions or other entities) enjoy an ability to encourage, motivate and reward customer behaviors and actions.

For example, John Doe may be assigned a unique customer identifier. John may have a credit card, debit card, savings account, checking account, and home mortgage with his bank. Activities associated with all of those accounts (or “relationships”) may be rewarded and rewards may be tracked at an aggregate level using John's unique customer identifier.

Moreover, as stated above, in some embodiments, rewards earned across multiple accounts (or “relationships”) may be aggregated. For example, if John Doe wants to amass rewards to use for an upcoming trip, he may create an account group (with his credit card and his debit card) to earn points for his upcoming trip to Paris (he may, for example, name the group “Trip to Paris”). John may create another account group (with his savings account, checking account, and mortgage account) to earn rewards for his child's 529 account (the group may be named for example, “529 Account”). Further, pursuant to some embodiments, John may earn rewards based on activities associated with accounts or relationships with other providers (e.g., such the use of a credit card issued by a second financial institution). Other features and benefits of some embodiments will become apparent from the following description.

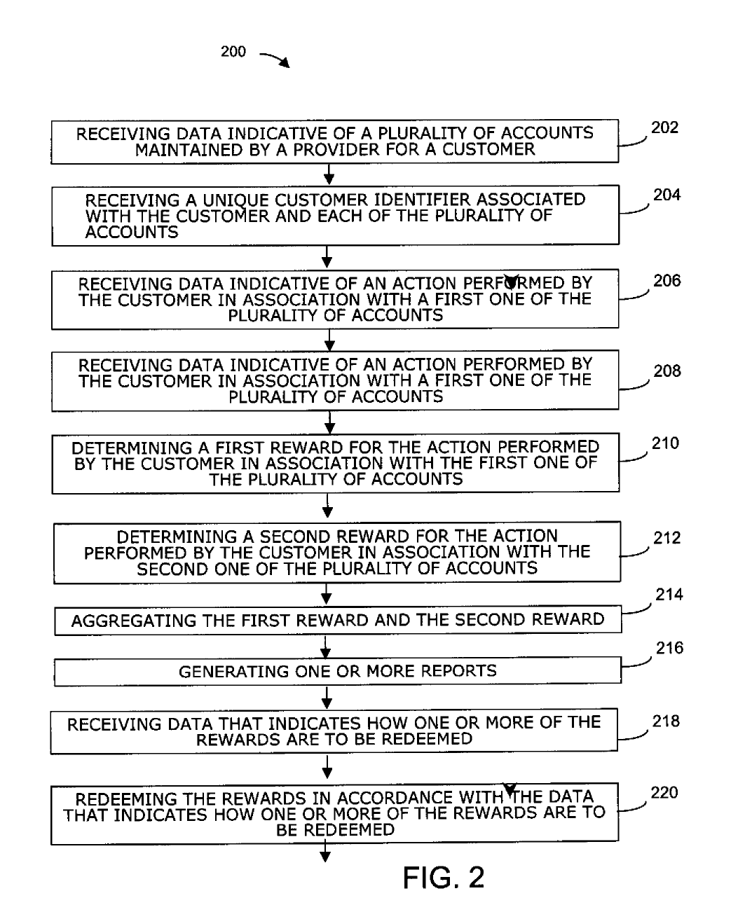

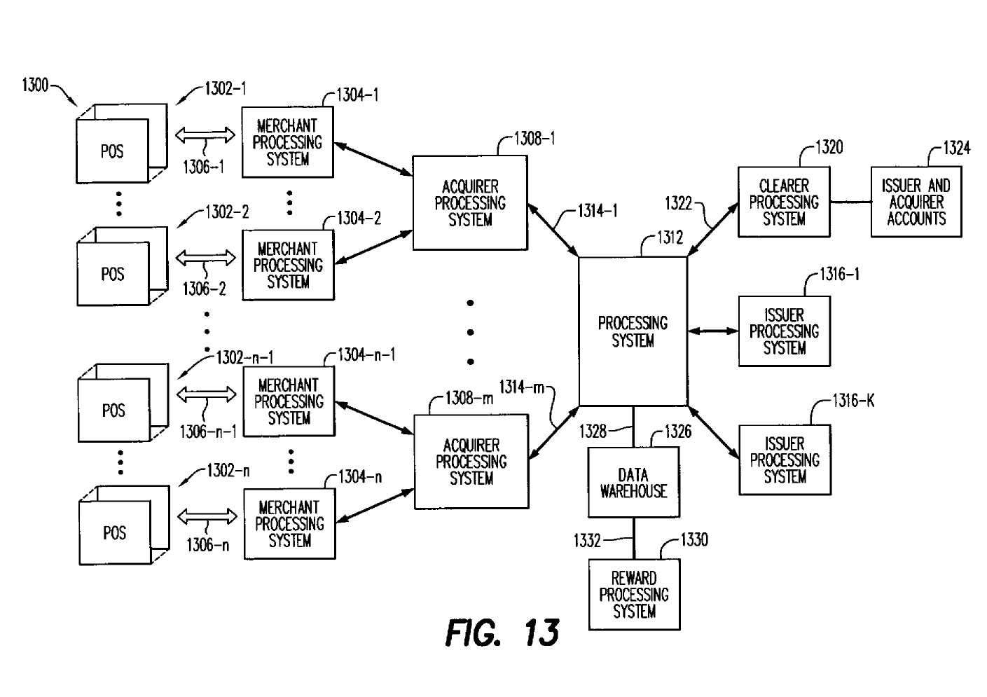

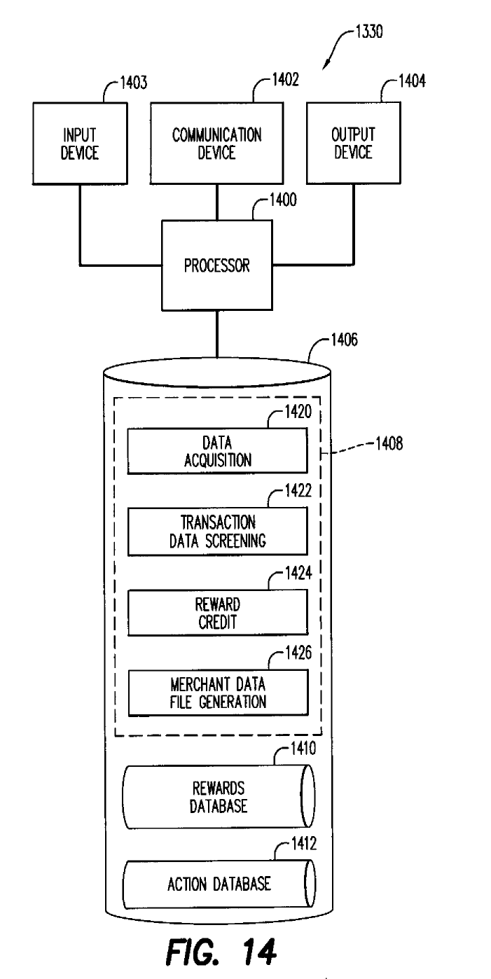

FIG. 2 is a flow chart of a method 200 according to some embodiments. The method 200 is not limited to the order shown in the flow chart. Rather, embodiments of the method 200 may be performed in any order that is practicable. For that matter, unless stated otherwise, any method disclosed herein may be performed in any order that is practicable. Moreover, unless stated otherwise, the method 200 may be performed by in any manner. In that regard, in some embodiments, one or more portions of one or more methods may be performed by a processing system. As further described hereinafter, in some embodiments, a processing system may comprise hardware, software (including microcode), firmware, or any combination thereof. In some embodiments, one or more portions of one or more methods disclosed herein may be performed by a processing system. In some embodiments, a processing system comprises a processing system such as the processing system in FIG. 13 and/or the processing system in FIG. 14.

The method, or one or more portions thereof, may be used in association with one or more rewards programs provided by one or more provider for one or more customers of the provider(s) to encourage customer actions involving one or more accounts or relationships with the one or more provider(s). Those skilled in the art will recognize that a reward program pursuant to some embodiments may be any of a number of different types of physical embodiments.

Referring to FIG. 2, at 202, the method may include receiving data indicative of a plurality of accounts maintained by a provider for a customer. The plurality of accounts may comprise any type(s) of accounts. As used herein, the term “account” may also refer to a “relationship” between a customer and a provider for which the provider desires to encourage, motivate, or reward action. In some embodiments, an account may be a financial account and/or a non-financial account. In should be noted that payment accounts may not be limited to payment card products. In that regard, in some embodiments, rewards may be earned for other types of relationships other than payment card or financial account relationships.

As an illustrative example, which will be utilized throughout this disclosure to illustrate features of some embodiments, a relationship involves a financial account relationship between a customer and a financial services entity (the “provider”). In some embodiments, a bank or other type of financial institution may desire to provide an incentive for customers to use an online banking system of the bank or other type of financial institution. In some such embodiments, the bank or other type of financial institution may provide a reward program in which customers may earn points, miles, cash and/or other type of reward for performing one or more actions in association with the online banking system. In some embodiments, customers may earn points, miles, cash and/or other type of reward each time they use the online banking system.

A provider may be any type of provider. Thus, in some embodiments, providers are not limited to financial institutions. For example, a website provider may desire to create an incentive for the customer to visit the website of the provider. To that effect, in some embodiments, customers may earn points, miles, cash and/or other type of reward each time they visit the website.

In some embodiments, each account (or “relationship”) is represented by an account identifier. In some such embodiments, each account identifier may comprise one or more alphanumeric characters.

The data indicative of the plurality of accounts may be supplied by any suitable source(s) of such data. In some embodiments, one or more portions of the data may be supplied, directly and/or indirectly, by the provider. For example, in some embodiments, providers may transmit a file or other source of data, to a rewards administrator (such as the rewards administrator 116 of FIG. 1B).

In some embodiments, one or more portions of the data may be supplied, directly and/or indirectly, by the customer. In that regard, in some embodiments, the customer may supply one or more portions of the data via a website. If the customer is supplying one or more portions of the data via a website, the customer may employ a user interface. In some embodiments, a user interface may include a personal computer that executes a browser program, receives signals from one or more input devices, for example, a mouse and/or keyboard, supplies signals to one or more output devices, for example, a display, and forwards the personal information to the financial institution.

In some embodiments, one or more portions of the data may be supplied, directly and/or indirectly, by the provider and one or more portions of the data may be supplied directly and/or indirectly, by the customer.

At 204, the method may further include receiving a unique customer identifier associated with the customer and each of the plurality of accounts. In some embodiments, the unique customer identifier may comprise one or more alphanumeric characters. The unique customer identifier may be supplied by any suitable source(s). In some embodiments, one or more portions of the unique customer identifier may be supplied, directly and/or indirectly, by the provider. Pursuant to some embodiments, by using a unique customer identifier for each customer, data associated with different accounts from different providers, may be associated with individual customers. This allows, for example, even individual providers to gain insight into their relationships with customers who have multiple accounts or relationships with them. Even further, this allows the aggregation of information associated with individual customers across multiple providers having multiple account relationships with the customers. For example, processing at 204 may include assigning a new unique customer identifier to a new customer and then using the unique customer identifier to aggregate information about each of the individual customer's account relationships with each provider. For existing customers (who already have been assigned a unique customer identifier), processing at 204 may include associating new account data from one or more providers with the unique customer identifier. In this manner, embodiments allow new and existing customers to add information identifying their various account relationships with one or more providers. This allows the system of the present invention to track, manage, and administer relationship reward programs on behalf of the customer across multiple relationships with multiple providers.

At 206, the method may further include receiving data indicative of an action performed by the customer in association with a first one of the plurality of accounts. In accordance with some embodiments, an action is not limited to a financial transaction. In that regard, in some embodiments, an action may be any type of action or activity.

In some embodiments, data indicative of the action may indicate the action, a date of the action, an amount associated with the action and/or a location of the action. In some embodiments, an action may comprise a purchase and transaction data for the transaction may include information that identifies one or more items purchased in the transaction, a date of the transaction, an amount of the transaction and/or a location of the transaction. In some embodiments, some or all of this information may be stored, after clearing of the transaction, in the data warehouse along with any other transaction data for the transaction. In some embodiments, item identifying information may, for example, be in the form of a stock keeping unit (SKU) number, or a Universal Product Code (UPC) number.

In some embodiments, receiving data indicative of an action performed by the customer may comprise receiving transaction data from a data warehouse and/or receiving transaction data from an administrator of a network and/or transactions.

In some embodiments, receiving data may comprise receiving data indicative of all actions performed by the customer in association with the plurality of accounts.

At 208, the method may further include receiving data indicative of an action performed by the customer in association with a second one of the plurality of accounts. As stated above, in some embodiments, receiving data indicative of an action performed by the customer may comprise receiving transaction data from a data warehouse and/or receiving transaction data from an administrator of a network and/or transactions.

As stated above, in accordance with some embodiments, an action is not limited to a financial transaction. In that regard, in some embodiments, an action may be any type of action.

At 210, the method may further include determining a first reward for the action performed by the customer in association with the first one of the plurality of accounts. In some embodiments, the first reward may be determined based at least in part on data that defines the one or more rewards programs. Such data may include criteria for use in determining whether an action qualifies for a reward, and if so, the type and/or amount of the reward. In some embodiments, data indicative of the action may be compared with such criteria to determine whether the action qualifies for a reward. In some embodiments, the action may comprise a purchase or other type of transaction. In some embodiments, the transaction data may be compared with the data that defines the reward program to determine whether the purchase transaction qualifies for a reward.

In some embodiments, the criteria may comprise one or more rules for use in determining whether an action qualifies for a reward, and if so, the type and/or amount of the reward. In some embodiments, the one or more rules define a rate or rates at which rewards are earned. In some embodiments, rewards are earned at a rate of one point per dollar spent, one mile per dollar spent, and/or one percent cash back per dollar spent. In some embodiments, the one or more rules define one or more tiers. In some embodiments, rewards may be earned at a first rate until a magnitude is reached and may be earned at a second rate after the magnitude is reached. In some embodiments, the one or more rules define one or more caps. In some embodiments, the one or more rules define a monthly cap and/or an annual cap. In some embodiments, the one or more rules define one or more rates at which rewards are earned, one or more tiers and/or one or more caps. Such data may be supplied by any source or sources, which may include, but is not limited to the provider of the account.

In some embodiments, a reward may comprise a rebate. In some embodiments, a rebate may be any type of rebate and may be processed and/or redeemed in any way.

Some examples of accrual rules are listed below but are not limited to:

Bank Product: Credit Card

Accrual Rule: 1 pt per $1 spend

Bank Product: Debit Card

Accrual Rule: 0.5 pt per $1 spend

Bank Product: National Private Label Card

Accrual Rule: 2 pt per $1 spend at merchant—1 pt per $1 spend on all other transactions

Bank Product: Checking Account

Accrual Rule: 1 pt per $1 spend

Bank Product: Online Bill Pay

Accrual Rule: 10 pts for every bill paid online per month

Bank Product: Mortgage

Accrual Rule: 0.1% pt of principal mortgage balance (at end of month)

Bank Product: Auto Loan

Accrual Rule: 0.25% pt of loan balance (at end of month)

Bank Product: Automatic Deposit

Accrual Rule: 5 pts per deposit

Bank Product: Overdraft Line of Credit

Accrual Rule: 0.25 pt per $1 paid on interest

Promotion scenario for a bank customer: maintain accounts to earn a periodic (monthly or yearly) bonus based on a number of active accounts at the end of a period (month or year)

| # Bank Products | Points per Bank Product |
|---|---|
| 1-3 | 5 |
| 4-6 | 10 |
| 7-10 | 25 |
| >10 | 50 |

Example promotion scenario for a bank customer: shop at one or more designated retail business on Mother's Day or other holiday to earn a rebate in addition to points for the transaction (e.g., spend $100 earn a $20 rebate on next statement).

Example promotion scenario for a bank customer: maintain three active accounts for three months to earn additional reward (e.g., 500 points) in addition to points on activity for the accounts.

If a customer returns a purchase so as to obtain a credit, the rewards administrator may determine, by reviewing data in the data warehouse, that the purchase transaction has been reversed. The rewards administrator may determine whether a reversal of a reward is called for as a result of the reversal of the transaction.

At 212, the method may further include determining a second reward for the action performed by the customer in association with the second one of the plurality of accounts. In some embodiments, the second reward may be determined based at least in part on data that defines the one or more rewards programs. As stated above, such data may include criteria for use in determining whether an action qualifies for a reward, and if so, the type and/or amount of the reward.

At 214, the method may further include aggregating the first reward and the second reward. Aggregating may comprise any type of aggregating. In some embodiments, aggregating the first reward and the second reward may include summing the first reward and the second reward.

In some embodiments, the plurality of accounts may comprise only two accounts. In some other embodiments, the plurality of accounts may comprise more than two accounts.

In some embodiments, the method may include automatically aggregating all of the accounts associated with the unique customer identifier. In that regard, in some embodiments, the first account and the second account may comprise the only accounts associated with the unique customer identifier.

In some other embodiments, the method may include aggregating fewer than all accounts associated with the unique customer identifier. In that regard, in some embodiments, the first account and the second account may not be the only accounts associated with the unique customer identifier.

As further described below, in some embodiments, aggregating may comprise aggregating the first reward and the second reward in response to a request by the customer to aggregate rewards for the first account and the second account. For example, as discussed in the illustrative example presented above, if John Doe wants to amass rewards to use for an upcoming trip, he may create an account group (with his credit card and his debit card) to earn points for his upcoming trip to Paris (he may, for example, name the group “Trip to Paris”). John may create another account group (with his savings account, checking account, and mortgage account) to earn rewards for his child's 529 account (the group may be named for example, “529 Account”).

As further described below, in some embodiments, a customer may invite one or more friends and/or other customers to join an account group of the customer so that the customer will earn rewards based on one or more activities performed by the one or more friends and/or other customers. In that regard, in some embodiments, the method may further include aggregating the first reward, the second reward and at least one portion of at least one reward for at least one action performed by a second customer in association with at least one account maintained by the provider for the second customer.

At 216, the method may further include generating one or more reports. In some embodiments, one or more of the one or more reports may be provided, directly and/or indirectly, to the provider. In some embodiments, one or more of the one or more reports may be provided, directly and/or indirectly, to one or more customers.

A report may be of any type and/or form. In some embodiments, a report may comprise computer readable data on a computer readable medium. In some embodiments a report may comprise data on paper, a display device and/or another human readable medium.

In some embodiments, a report may be provided to a provider and/or customer using one or more of the following ways: in person, via direct mail, via email, via telephone, via a portable data assistant, via a website, via the Internet, and/or a combination thereof. In some embodiments, a provider and/or customer may have a system that is in communication with a website that provide reports. The system may include a user interface that receives signals from one or more input devices (for example, a mouse and/or keyboard) and/or supplies signals to one or more output devices (for example, a display). The provider and/or customer may use the one or more input devices to request a report from the website and may view a report from the website via the one or more output devices.

At 218, the method may further include receiving data that indicates how one or more of rewards are to be redeemed.

In some embodiments, one or more portions of such data may be supplied, directly and/or indirectly, by the provider. For example, the reward program may require that rewards be redeemed for certain products and/or services. In some embodiments, one or more portions of the data may be supplied directly and/or indirectly, by the customer. For example, the rewards program may give the customer a choice as to how to redeem rewards. In some embodiments, one or more portions of the data may be supplied, directly and/or indirectly, by the provider and one or more portions of the data may be supplied directly and/or indirectly, by the customer.

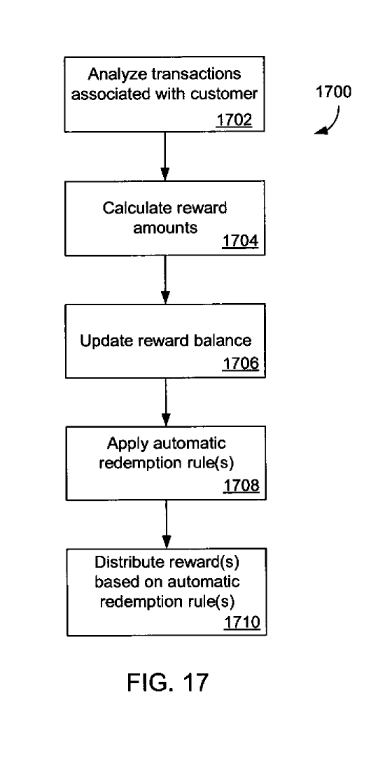

In some embodiments, the data may include one or more automatic redemption triggers. In some embodiments, an automatic redemption trigger may comprise an automatic redemption trigger specified by a customer. For example, John Doe may specify that every time he earns $10 of rewards that the $10 will be automatically posted to his “529 Account” group. Further details of some embodiments of the use of automatic redemption triggers are provided below in conjunction with FIG. 17. In accordance with some embodiments, John may also manually redeem points.

At 220, the method may further include redeeming the rewards in accordance with the data that indicates how one or more of the rewards are to be redeemed. In some embodiments, the reward administrator may perform (i.e., fulfill) the redemption. In some other embodiments, the reward administrator may generate a message to notify the provider and/or an entity that performs fulfillment.

As stated above, in some embodiments, a customer may define one or more different account “groups” to earn rewards. For example, if John Doe wants to amass rewards to use for an upcoming trip, he may create one account group (with his credit card and his debit card) to earn points for his upcoming trip to Paris (he may, for example, name the group “Trip to Paris”). John may create a second account group (with his savings account, checking account, and mortgage account) to earn rewards for his child's 529 account (the group may be named for example, “529 Account”).

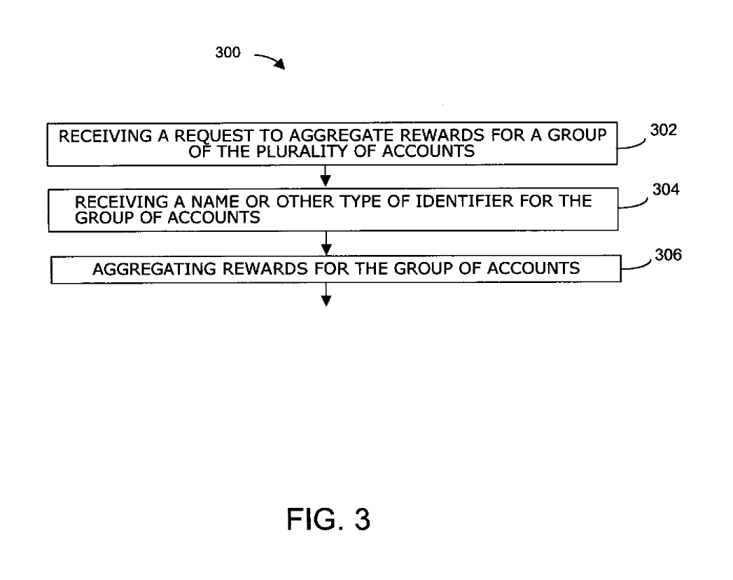

FIG. 3 is a flow chart of a method 300 according to some embodiments. In some embodiments, one or more portions of one or more methods disclosed herein may be performed by a processing system. In some embodiments, a processing system comprises a processing system such as the processing system in FIG. 13 and/or the processing system in FIG. 14.

Referring to FIG. 3, at 302, the method may include receiving a request to aggregate rewards for a group of the plurality of accounts. Such request may have any form. In some embodiments, the request may comprise a request by the customer. In some embodiments, the request may comprise define a group of the plurality of accounts and a request to aggregate rewards for the group.

At 304, the method may further include receiving a name or other type of identifier for the group of accounts. In some embodiment, the identifier may comprise one or more alphanumeric characters. For example, if John Doe wants to amass rewards to use for an upcoming trip to Paris, he may create an account group, and may, for example, name the account group “Trip to Paris”).

At 306, the method may further include aggregating rewards for the group of accounts. As stated above, aggregating may comprise any type of aggregating. In some embodiments, the group of accounts may comprise only two accounts. In some other embodiments, the group of accounts may comprise more than two accounts.

As stated above, in some embodiments, a customer may invite one or more friends and/or other customers to join their account group so that the customer will earn rewards based on one or more activities performed by the one or more friends and/or other customers in association with one or more accounts of the friends and/or other customers with the provider.

For example, John Doe may invite his girlfriend Jane to associate her credit card account with John's “Trip to Paris” group of accounts. Jane's use of her card will earn John points that he may redeem for use for his upcoming Paris trip.

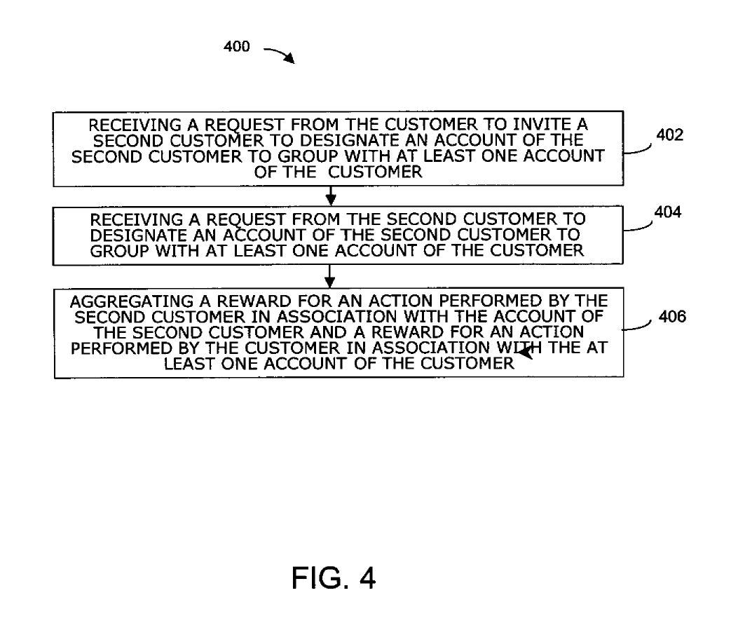

FIG. 4 is a flow chart of a method 400 according to some embodiments. In some embodiments, one or more portions of one or more methods disclosed herein may be performed by a processing system. In some embodiments, a processing system comprises a processing system such as the processing system in FIG. 13 and/or the processing system in FIG. 14.

At 402, the method may include receiving a request from the customer to invite a second customer to designate an account of the second customer to group with at least one account of the customer.

At 404, the method may further include receiving a request from the second customer to designate an account of the second customer to group with at least one account of the customer

At 406, the method may further include aggregating a reward for an action performed by the second customer in association with the account of the second customer and a reward for an action performed by the customer in association with the at least one account of the customer.

In accordance with some embodiments, one or more methods may be used to enroll one or more customers in one or more rewards programs.

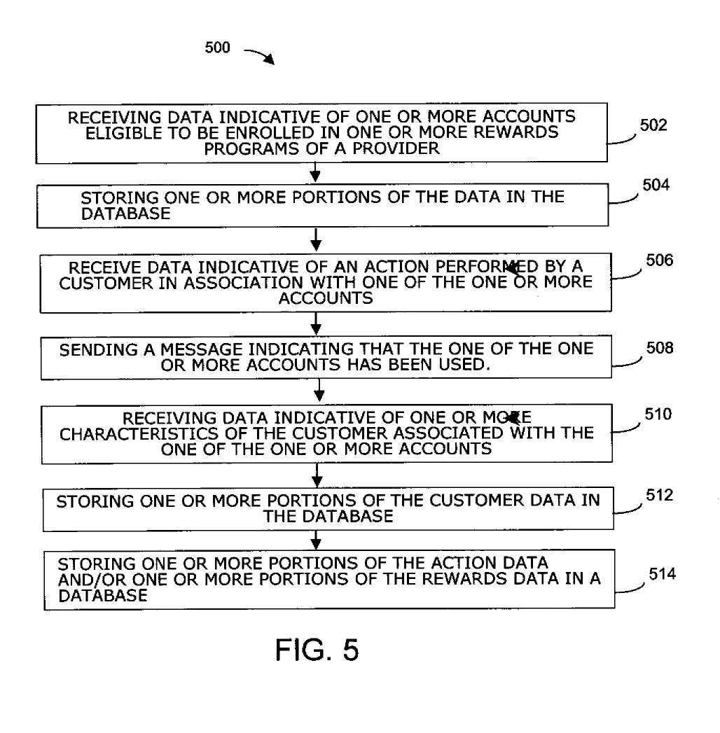

FIG. 5 is a flow chart of a method 500 according to some embodiments. In some embodiments, one or more portions of one or more methods disclosed herein may be performed by a processing system. In some embodiments, a processing system comprises a processing system such as the processing system in FIG. 13 and/or the processing system in FIG. 14.

Referring to FIG. 5, at 502, the method may include receiving data indicative of one or more accounts eligible to be enrolled in one or more reward programs of a provider. In some embodiments, the data may be received from the provider and/or any other source(s). In some embodiments, one or more portions of the data may be supplied on one or more computer readable medium. In some embodiments, one or more portions of the data may be uploaded from the provider via a network.

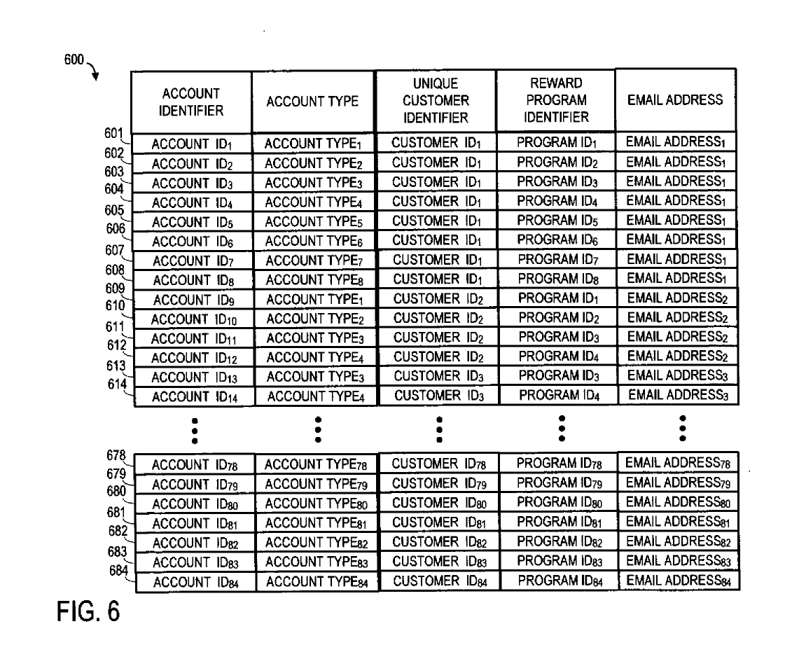

FIG. 6 is a diagrammatic representation of a data format 600 that may be employed in supplying data indicative of one or more accounts eligible to be enrolled in one or more reward programs of a provider, according to some embodiments.

Referring to FIG. 6, the data format 600 may include a plurality of records, e.g., 601-684. Each record may be associated with an account maintained by one (or more) provider(s). For example, the first record 601 may be associated with a first account maintained by a first provider. The second record 602 may be associated with a second account maintained by the provider. The third record 603 may be associated with a third account maintained by a second provider. The fourth record 604 may be associated with a fourth account maintained by the second provider, etc.

Each record may include a plurality of fields. In some embodiments, each record includes an account identifier field, an account type field, a unique customer identifier field and a reward program identifier field. The account identifier may indicate the account with which the record is associated. The account type identifier may indicate the type of the account with which the record is associated. If the provider is a financial institution that offers checking accounts, savings accounts, certificates of deposit, money markets, individual retirement accounts, debit cards, credit cards and/or other types of payment cards, auto loans, mortgages, home equity loans, auto loans and/or other types of loans, the account type identifier may indicate whether the account is a checking account, savings account, certificates of deposit, money market, individual retirement account, debit card, credit card and/or other type of payment card, auto loan, mortgage, home equity loan, auto loan and/or other type of loan.

In some embodiments, the account identifiers ACCOUNT ID₁-ACCOUNT ID₈₄ in records 601-684 may comprise a sequence of consecutive account numbers. In some other embodiments, the account identifiers ACCOUNT ID₁-ACCOUNT ID₈₄ in records 601-684 may not comprise a sequence of consecutive account numbers.

The unique customer identifier may comprise the unique customer identifier associated with the account. As such, the unique customer identifier may link the account to the customer for which the account is maintained. In the illustrated embodiment, accounts ACCOUNT ID₁-ACCOUNT ID₈ associated with records 601-608 are each associated with a first customer assigned a unique customer identifier CUSTOMER ID₁. Accounts ACCOUNT ID₉-ACCOUNT IDᵤ associated with records 609-612 are each associated with a second customer assigned a unique customer identifier CUSTOMER ID₂. Accounts ACCOUNT ID₁₃-ACCOUNT IDᵤᵢ associated with records 613-614 are each associated with a third customer assigned a unique customer identifier CUSTOMER ID₃.

The reward program identifier may indicate a reward program for which the account is eligible. If the provider offers a mileage reward program, a point reward program, a cash back reward program and/or other type of reward program or combination thereof, the reward program identifier may indicate whether the account is eligible for a mileage reward program, a point reward program, a cash back reward program and/or other type of reward program or combination thereof.

In some embodiments, a record may further include an email address field that may indicate an email address for the customer for which the account is maintained.

In some embodiments, a rewards system may administer rewards programs only for traditional payment card accounts. In some embodiments, the account identifier may comprise sixteen to nineteen alphanumeric characters.

In some embodiments, a rewards system may administer rewards programs for one or more types of accounts or relationships that are not traditional payment card accounts.

In some embodiments, a rewards system may administer rewards programs for traditional payment card accounts and one or more other types of accounts that are not traditional payment card accounts.

In some embodiments a rewards system may administer only non traditional rewards programs (in which rewards for different accounts may be aggregated together). In some embodiments a rewards system may administer only traditional rewards programs (in which rewards for different accounts are not aggregated together).

In some embodiments a rewards system may administer one or more traditional rewards programs (in which rewards for different accounts are not aggregated together) for one or more providers and one or more non traditional rewards programs (in which rewards for different accounts may be aggregated together).

In some embodiments, an account may be enrolled in only one account at a time. In some embodiments, an account may be enrolled in more than one reward program at a time.

Referring again to FIG. 5, at 504, the method may further include storing one or more portions of the data in a database. In accordance with some embodiments, the database may comprise one or more tables.

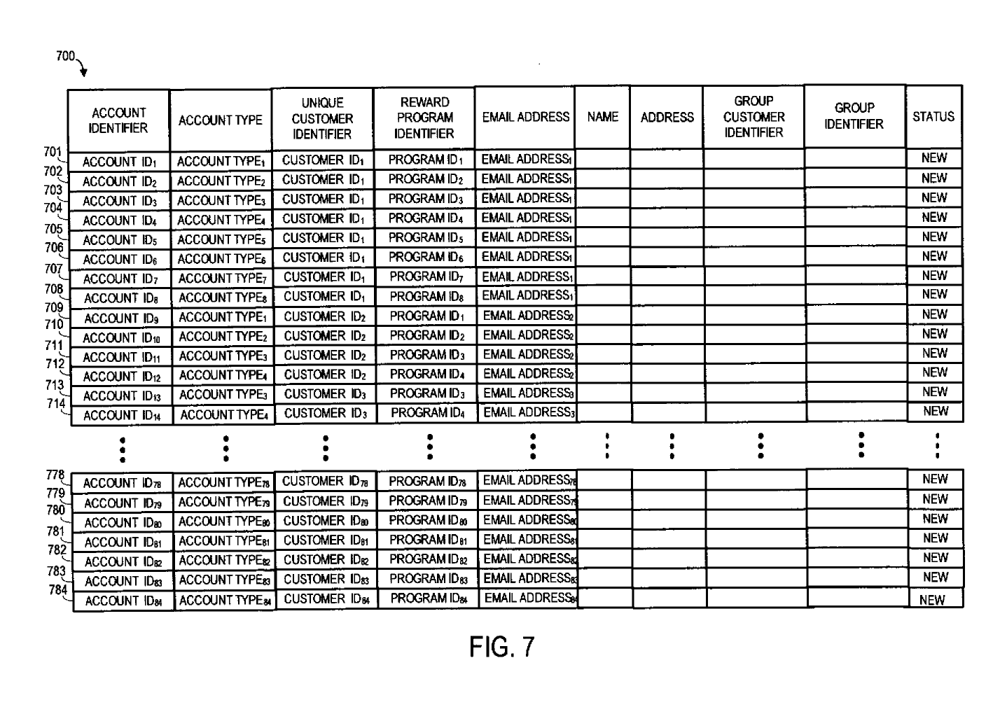

FIG. 7 is a diagrammatic representation of a data format 700 that may be used to store the data in some embodiments.

Referring to FIG. 7, the data format 700 may include a plurality of records, e.g., 701-784. Each record may be associated with an account maintained by one (or more) provider(s). For example, the first record 701 may be associated with a first account maintained by the provider. The second record 702 may be associated with a second account maintained by the provider. The third record 703 may be associated with a third account maintained by a second provider. The fourth record 704 may be associated with a fourth account maintained by the second provider, etc.

Each record may include a plurality of fields. In some embodiments, each record includes all of the fields of the data format 600 (FIG. 6). In some embodiments, each record may further include one or more fields for customer data (e.g., name and address), a group customer identifier field, a group identifier field, and a status field.

The group identifier field may indicate whether the account is part of a group. If the account is part of a group, the group customer identifier represents the owner of the group.

In some embodiments, the one or more fields for customer data (e.g., name and address), a group customer identifier field and a group identifier field, may initially be empty. In some embodiments, the status field may initially indicate that the status of the account associated with record is new.

In some embodiments, the account identifier may comprise sixteen to nineteen alphanumeric characters. In some embodiments, the account identifier may comprise thirty alphanumeric characters. In some embodiments, a rewards system may receive account identifiers of various lengths and may convert and/or pad such account identifiers to another length. In some embodiments, the rewards system converts and/or pads account identifiers as may be necessary to produce identifiers that are thirty alphanumeric characters in length.

In some embodiments the product type identifier may comprise alphanumeric characters.

At 506, the method may further include receiving data indicative of an action performed by a customer in association with one of the one or more accounts.

At 508, the method may further include sending a message indicating that the one of the one or more accounts has been used. In some embodiments, sending such message may comprise sending a message to the provider(s) that maintains the one or more accounts.

At 510, the method may further include receiving data indicative of one or more characteristics of the customer associated with the one of the one or more accounts. The customer data may include any type of data indicative of one or more characteristics of the customer. In that regard, in some embodiments, the customer data may include personal information for example, name, address, date of birth, the social security number of the customer and/or a status of the account. In some embodiments, the status of the account may indicate whether the account is in good standing. The customer data may be provided by any suitable source(s) of customer data. In some embodiments, the customer data may be provided by the provider.

At 512, the method may further include storing one or more portions of the customer data in the database.

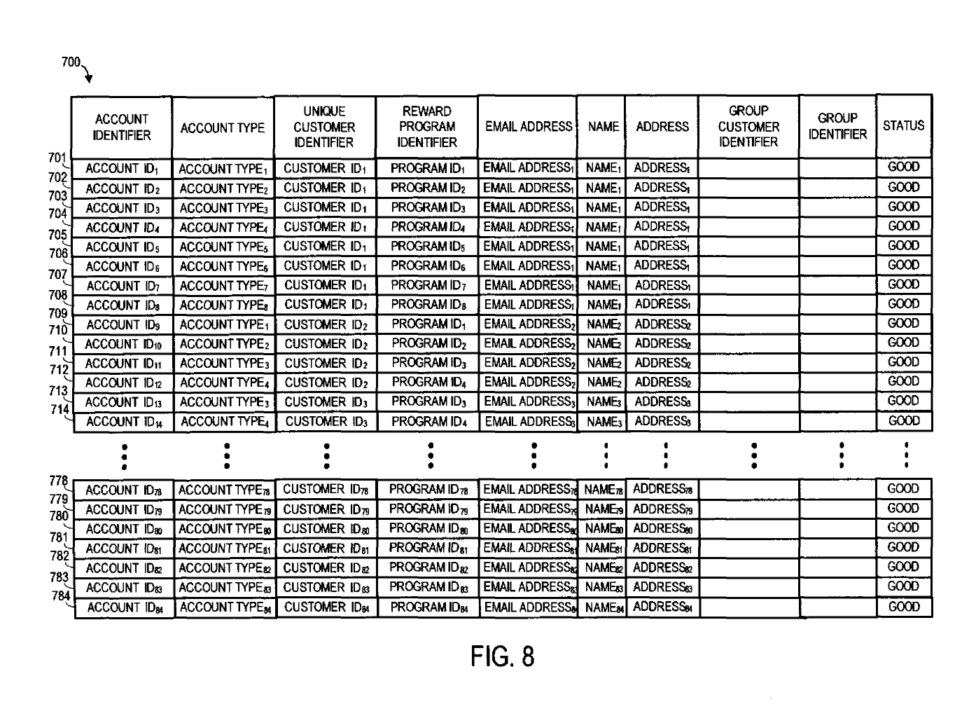

FIG. 8 is a diagrammatic representation of the data format 700, which may be used to store the data in some embodiments, after all of the accounts in records 701-784 have been used at least once and after the associated customer data (e.g., name and address) is received and stored therein.

In some embodiments, the status field may be updated to indicate that the account is no longer new and whether the account is in good standing.

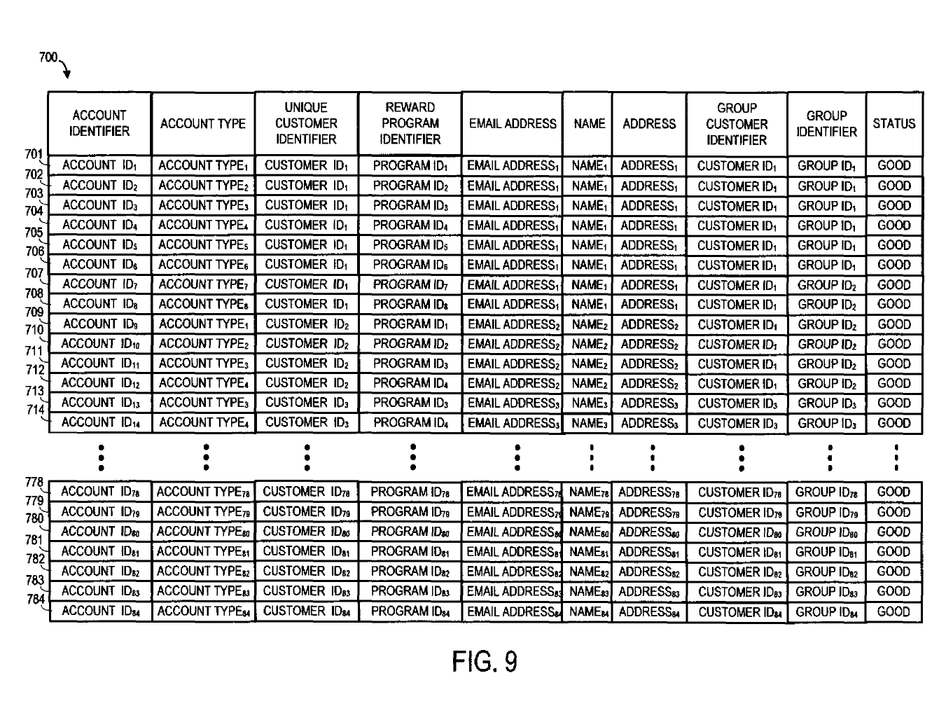

FIG. 9 is a diagrammatic representation of the data format 700, which may be used to store the data in some embodiments, after all of the accounts in records 701-784 have been used at least once and after the associated customer data (e.g., name and address) is received and stored therein.

In the illustrated embodiment, the group customer identifier field and the group identifier field collectively indicate that the accounts associated with records 701-706 are part of a group that is assigned identifier GROUP ID₁ and owned by the first customer assigned the unique customer identifier CUSTOMER ID₁. The accounts associated with records 707-708 are part of a group that is assigned identifier GROUP ID₂ and owned by the first customer assigned the unique customer identifier CUSTOMER ID₁. The accounts associated with records 709-712 are part of a group that is assigned identifier GROUP ID₂ and owned by the first customer assigned the unique customer identifier CUSTOMER ID₁. The accounts associated with records 713-714 are part of a group that is assigned identifier GROUP ID₃ and owned by the third customer assigned the unique customer identifier CUSTOMER ID₃.

Referring again to FIG. 5, at 514, the method may further include storing one or more portions of the action data and/or one or more portions of the reward data in a database. In accordance with some embodiments, the database may comprise one or more tables.

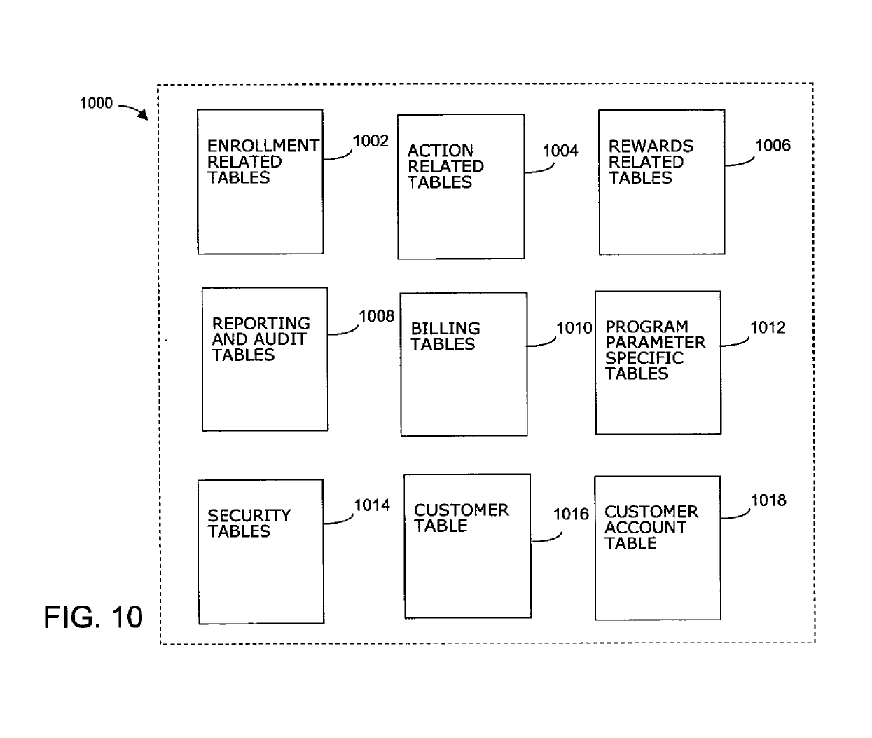

FIG. 10 is a diagrammatic representation of a database that may be employed, according to some embodiments.

Referring to FIG. 10, the database 1000 may include a plurality of tables including enrollment related tables 1002, action related tables 1004, rewards related tables 1006, reporting and audit tables 1008, billing tables 1010, program parameter specific tables 1012, security tables 1014, a customer table 1016 and a customer account table 1018.

The enrollment related tables 1002 may include data for a plurality of accounts. In some embodiments, the tables may include one record per account. The action related tables 1004 may include data indicative of a plurality of transactions or other types of actions performed by one or more customers. In some embodiments, the tables may include one record per transaction or other action. The rewards related tables 1006 may include data indicative of rewards accrued by customers of each provider and/or redemptions credited against each provider. The reporting and audit tables 1008 may include enrollment reports, rewards reports and redemption reports. The billing tables 1010 may include data employed in billing and/or paying providers and vendors. The security tables 1014 may include data that indicates who can perform customer service related operations within the rewards system, e.g., who can make adjustments (e.g., give points back) to accounts.

As further described below, in some embodiments, customers may be given the ability to log onto a web interface and enroll and/or to associate one or more new accounts with the unique customer identifier assigned to the customer.

As stated above, in some embodiments, one or more reports may be generated. In some embodiments, one or more of the one or more reports may be provided to the provider. In some embodiments, one or more of the one or more reports may be provided to one or more customers.

In some embodiments, one or more reports may be generated at regular intervals. In some embodiments, one or more reports may be generated at times other than regular intervals.

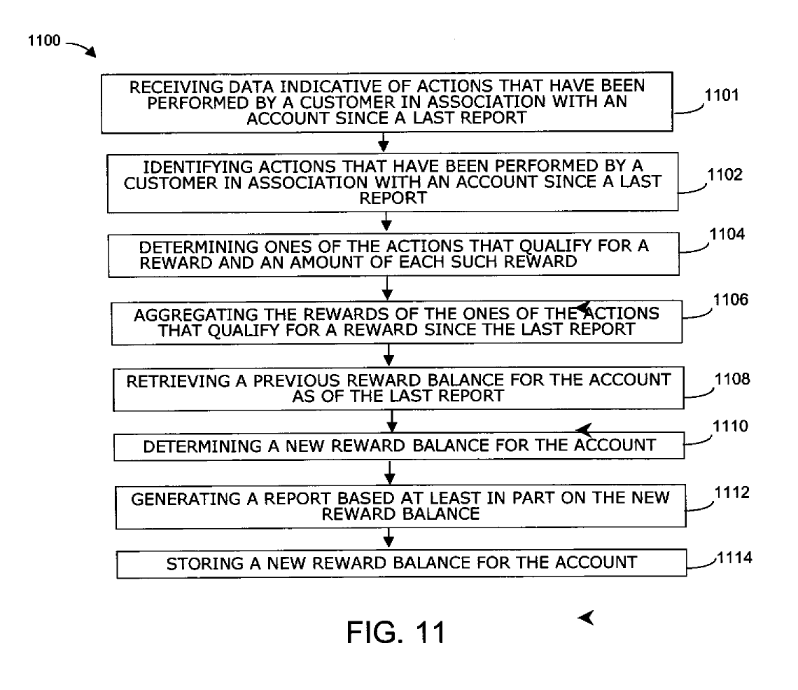

FIG. 11 is a flow chart of a method 1100 according to some embodiments. In some embodiments, one or more portions of one or more methods disclosed herein may be performed by a processing system such as the processing system in FIG. 13 and/or the processing system in FIG. 14.

Referring to FIG. 11, at 1101, the method may include receiving data indicative of transactions or other actions that have been performed by a customer in association with an account since a last report. In some embodiments, data may be received in batches. In some embodiments, the rewards administrator fetches a batch of transaction data from the data warehouse 114. In that regard, in some embodiments, the batch of data may only include transactions or other actions that the rewards system has not previously screened.

At 1102, the method may include identifying actions that have been performed by a customer in association with an account since a last report.

At 1104, the method may further include determining ones of the actions that qualify for a reward and an amount of each reward.

At 1106, the method may further include aggregating the rewards earned since the last report.

At 1108, the method may further include retrieving a previous reward balance for the account as of the last report.

At 1110, the method may further include determining a new reward balance for the account. In some embodiments, a new reward balance may be based at least in part on a previous reward balance for the account, rewards earned since the last report and rewards redeemed since the last report. In that regard, in some embodiments, the method may include determining a sum of a previous reward balance for the account and rewards earned since the last report, and subtracting, from the sum, the rewards redeemed since the last report.

At 1112, the method may further include generating a report based at least in part on the new reward balance.

At 1114, the method may further include storing a new reward balance for the account.

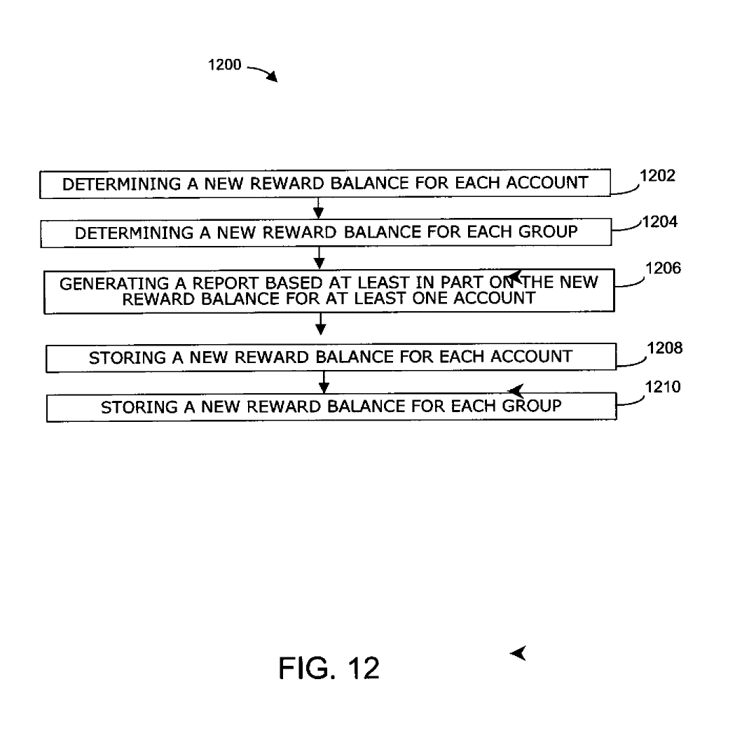

FIG. 12 is a flow chart of a method 1200 according to some embodiments. In some embodiments, one or more portions of one or more methods disclosed herein may be performed by a processing system. In some embodiments, a processing system comprises a processing system such as the processing system in FIG. 13 and/or the processing system in FIG. 14.

Referring to FIG. 12, at 1202, the method may include determining a new reward balance for each account of a customer. In some embodiments, a reward balance for an account may be determined using one or more portions of the method 1100 (FIG. 11).

At 1204, the method may include determining a new reward balance for each group. In some embodiments, a reward balance may be based at least in part on a previous reward balance for the group, rewards earned since the last report and rewards redeemed since the last report. In that regard, in some embodiments, the method may include determining a sum of a previous reward balance for the group and rewards earned since the last report, and subtracting, from the sum, the rewards redeemed since the last report.

In some embodiments, accounts belonging to a group may all be associated with the same group customer identifier and group identifier (FIGS. 7-9).

At 1206, the method may further include generating a report based at least in part on the new reward balance for at least one account.

At 1208, the method may further include storing a new reward balance for each account.

At 1210, the method may further include storing a new reward balance for each group.

As stated above, in some embodiments, one or more reports may be generated from time to time. In some embodiments, the reports may be generated at regular intervals. In some embodiments, one or more reports may be generated at times other than regular intervals.

FIG. 13 is a block diagram representation of a processing system 1300 according to some embodiments. In some embodiments, the processing system 1300 may be used in processing transactions between one or more customers and one or more merchants.

As used herein, a customer may comprise any type of customer. In some embodiments, a customer comprises a previous customer, a current customer, a prospective customer and/or a future customer.

As stated above, a merchant may comprise any type of merchant. In some embodiments, a merchant comprises a provider of good(s) and/or service(s) including but not limited to a retail business, a restaurant, a hotel, a bank or other type of financial institution, an airline or other type of transportation provider and/or a telephone, television, Internet or other type of communication provider.

A processing system may be any type of processing system. For example, a processing system may be programmable or non programmable, digital or analog, general purpose or special purpose, dedicated or non dedicated, distributed or non distributed, shared or not shared, and/or any combination thereof. A processing system may employ continuous signals, periodically sampled signals, and/or any combination thereof. If the processing system has two or more distributed portions, the two or more portions may communicate with one another through a communication link. A processing system may include, for example, but is not limited to, hardware, software, firmware, hardwired circuits and/or any combination thereof.

In some embodiments, a processing system may include any sort or implementation of software, program, sets of instructions, code, ASIC, or specially designed chips, logic gates, or other hardware structured to directly effect or implement such software, programs, sets of instructions or code. The software, program, sets of instructions or code can be storable, writeable, or savable on any computer usable or readable media or other program storage device or media such as, for example, floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

A communication link may be any type of communication link, for example, but not limited to, wired (e.g., conductors, fiber optic cables) or wireless (e.g., acoustic links, electromagnetic links or any combination thereof including, for example, but not limited to microwave links, satellite links, infrared links), and/or combinations thereof, each of which may be public or private, dedicated and/or shared (e.g., a network). A communication link may or may not be a permanent communication link. A communication link may support any type of information in any form, for example, but not limited to, analog and/or digital (e.g., a sequence of binary values, i.e. a bit string) signal(s) in serial and/or in parallel form. The information may or may not be divided into blocks. If divided into blocks, the amount of information in a block may be predetermined or determined dynamically, and/or may be fixed (e.g., uniform) or variable. A communication link may employ a protocol or combination of protocols including, for example, but not limited to the Internet Protocol.

Referring to FIG. 13, the processing system 1300 may include one or more POS (point of service, point of sale, and/or point of transaction) 1302-1 to 1302-n. A POS may be any type of POS. In some embodiments, a POS may comprise (1) a terminal in an establishment of a merchant visited by a customer, (2) an online commerce site (e.g., an Internet commerce site that may receive payment account numbers from customers who shop online) operated by and/or for a merchant and/or (3) a terminal of a mail order and/or telephone (MOTO) merchant who may receive payment account numbers by mail and/or telephone.

In some embodiments, the one or more POS 1302-1 to 1302-n may comprise tens, hundreds, thousands or even millions of POS's. The one or more POS 1302-1 to 1302-n may or may not be identical (or even similar) to one another.

The one or more POS 1302-1 to 1302-n may be coupled to one or more merchant processing systems. For example, POS 1302-1 may be coupled to a merchant processing system 1304-1. POS 1302-n may be coupled to a merchant processing system 1304-n. POS 1302-1 may be coupled to the merchant processing system 1304-1 by a communication link 1306-1. POS 1302-n may be coupled to the merchant processing system 1304-n by a communication link 1306-n.

The one or more merchant processing systems 1304-1 to 1304-n may or may not be identical to one another. In some embodiments, one or more of the merchant processing systems 1302-1 to 1302-n may comprise, for example, a conventional personal computer.

In some embodiments, one or more of the processing systems described herein may operate and/or may be programmed in accordance with one or more embodiments disclosed herein.

The one or more merchant processing systems 1304-1 to 1304-n may be coupled to one or more acquirer processing systems. For example, merchant processing system 1304-1 may be coupled to an acquirer processing system 1308-1. Merchant processing system 1304-n may be coupled to an acquirer processing system 1308-n. Merchant processing system 1304-1 may be coupled to the acquirer processing system 1308-1 by communication link 1310-1. Merchant processing system 1304-n may be coupled to the acquirer processing system 1308-n by communication link 1310-n. In some embodiments, one or more of the acquirer processing systems 1308-1 to 1308-m comprises a bank processing system.

The one or more acquirer processing systems 1308-1 to 1308-m may be coupled to a payment processing system 1312. The acquirer processing system 1308-1 may be coupled to the payment processing system 1312 by a communication link 1314-1. The acquirer processing system 1308-m may be coupled to the payment processing system 1312 by a communication link 1314-m.

The payment processing system 1312 may be coupled to one or more issuer processing systems 1316-1 to 1316-k. The payment processing system 1312 may be coupled to the issuer processing system 1316-k by communication link 1318-1. The payment processing system 1312 may be coupled to the issuer processing system 1316-k by communication link 1318-k.

In some embodiments, issuer processing systems 1316-1 to 1316-k may be operated by one or more financial institutions that have issued payment cards.

The payment processing system 1312 may also be coupled to a clearing bank processing system 1320. The payment processing system 1312 may be coupled to the clearing bank processing system 1320 by a communication link 1322. The clearing processing system may administer one or more accounts 1324, which may include one or more acquirer accounts and one or more issuer accounts. In some embodiments, the clearing processing system may be operated by or on behalf of a payment card association such as MasterCard International, Inc.

In some embodiments, the clearing processing system 1320 is operated by a bank or other financial institution that represents a payment card association and handles the actual exchange of funds among issuers and acquirers as needed to settle purchases and/or other types of transactions cleared by the clearer processing system 1320.

In some embodiments, the clearing processing system 1320 may be integrated into the payment processing system 1312.

The payment processing system 1312 may also be coupled to a data warehouse 1326. The payment processing system 1312 may be coupled to the data warehouse 1326 by a communication link 1328.

The data warehouse 1326 may be coupled to a rewards processing system 1330. The data warehouse 1326 may be coupled to the rewards processing system 1330 by a communication link 1332.

In some embodiments, the data warehouse 1326 and/or the rewards processing system 1330 may be operated by a payment card association such as MasterCard International, Inc.

In some embodiments, the data warehouse 1326 and/or the rewards processing system 1330 may be integrated into the payment processing system 1312.

In some embodiments, the operation of the processing system 1300 may be as follows. A customer may desire to purchase good(s) and/or service(s) from a merchant, e.g., a merchant associated with merchant processing system 1304-1. The customer may desire to pay for the purchase using a payment account. A payment account may be any type of payment account. In some embodiments, a payment account may comprise a credit card account and/or a debit card account.

Data indicative of the transaction, sometimes referred to as transaction data, may be supplied to and/or received by a POS, e.g., POS 1302-1, associated with the merchant. The transaction data may include data indicative of a purchase price, sometimes referred to herein as purchase price data, and data indicative of the payment account, sometimes referred to herein as payment account data.

In some embodiments, the payment account data comprises a credit card account number and/or a debit card account number. The payment account data may be in any form, for example, but not limited to, analog and/or digital (e.g., a sequence of binary values, i.e. a bit string) signal(s) in serial and/or in parallel form.

The transaction data may be supplied by any suitable source(s). In some embodiments, one or more portions of the purchase price data may be supplied, directly and/or indirectly, by an employee of the merchant. In some embodiments, one or more portions of the payment account data may be supplied, directly and/or indirectly, by the customer.

In some embodiments, the purchase price data and/or the payment account data may be supplied using human data entry or the like. In that regard, in some embodiments, data may be supplied through a user interface such, for example a keyboard, a mouse, a touchpad, a voice recognition system.

In some embodiments, the POS, e.g., POS 1302-1, may generate a total dollar amount due for the transaction.

If the POS comprises a transaction terminal located in an establishment (e.g., a retail store, restaurant, hotel, bank) that is visited by the customer, the payment account data may be supplied by a payment card, for example, (e.g., a credit or debit card). In some embodiments, for example, a payment card may be swiped through and/or appropriately presented to a payment card reader for the transaction terminal.

If a POS comprises an online commerce site, the customer may supply one or more portions of the payment account number through a user interface. In some embodiments, a user interface may include a personal computer that executes a browser program, receives signals from one or more input devices, for example, a mouse and/or keyboard, supplies signals to one or more output devices, for example, a display and/or to a network connected to the online commerce site.

In some embodiments, for example, but not limited in the case of an online commerce site, a POS and the associated merchant processing system may be integrated together into a single processing system. In some embodiments, a POS may communicate directly with an acquirer computer 1306, without an intervening merchant processing system. In some embodiments, the processing system 1300 may be used to carry out one or more portions of one or more embodiments of one or more methods disclosed herein.

The merchant processing system, e.g., merchant processing system 1304-1, may send a message, sometimes referred to herein as an authorization request, which may include the transaction data and/or other customary information.

The authorization request may be supplied to an acquiring processing system, e.g., acquiring processing system 1308-1, which may send the authorization request to the processing system 1312. The processing system 1312, which may comprise payment card association data processing facilities, may determine the issuer of the payment card and may send the authorization to an issuer processing system, e.g., issuer processing system 1316-1, associated with such issuer. The issuer processing system, e.g., issuer processing system 1316-1, may determine whether to approve the transaction, e.g., based at least in part on whether the payment card account number is valid, whether the account remains active, whether there is adequate credit or enough funds in the account to support the transaction, etc.

Thereafter, the issuer processing system, e.g., issuer processing system 1316-1, may send a message, sometimes referred to herein as a response, which may be supplied through the communication path of the original authorization request and back to the POS, e.g., POS 1302-1. If the response indicates that the transaction is approved, the customer may receive the good(s) and/or service(s) purchased from the merchant. The response may either approve the transaction or decline the transaction. If the transaction is approved, a “hold” may be placed on the payment card account in the amount of the transaction total, and the transaction may be allowed to proceed at the POS terminal.

If the transaction is approved, the merchant processing system, e.g., merchant processing system 1304-1, may submit the transaction for clearing. In some embodiments, the merchant submits the transaction for clearing in a batch process with other transactions at the close of business or overnight.

In some embodiments, for each transaction, some or all of the following data may be submitted: (a) payment account number (i.e., the payment card number), (b) the brand applied to the card by the issuing financial institution, (c) the dollar amount of the transaction, (d) the type of the payment card (consumer versus fleet/corporate), (e) the date of the transaction, (f) a “processing code” that indicates the type of transaction (in this case assumed to be a purchase transaction), (g) a code to indicate whether the transaction was at a retail POS terminal, versus an online, mail order or telephone transaction, (h) a code to indicate whether the card presented was a magnetic stripe card or a smart card, (i) a code that identifies the POS terminal from among the merchant's other POS terminals, (j) the name of the merchant, and (k) the currency (e.g., dollars) in which the transaction was conducted. Other data may also be included in the data submitted for the transaction.

The acquirer processing system, e.g., acquirer processing system 1308-1, may send a message, sometimes referred to herein as a clearing request, to the processing system 1312 indicating that the issuer processing system, e.g., issuer processing system 1316-1, has approved the transaction. In addition to the data received from the merchant processing system, the message from the acquirer processing system may also include the following additional data: (l) a code that identifies the acquirer, and (m) (for each transaction) a code that identifies the issuer of the payment card tendered for the transaction.

The processing system 1312 may send a message to the clearer processing system 1320 to confirm that the issuer and the acquirer each have an account, and to confirm that the issuer has sufficient funds on deposit in its account to pay for the transaction.

In some embodiments, the clearing processing system 1320 may receive clearing requests in batches. The clearer processing system 1320 may receive the transaction data, e.g., in a batch, and may perform various validation processes for each transaction to confirm that the data for such transaction is complete and valid.

The clearing processing system 1320 may provide acknowledgements that the purchase and/or other transactions requested by the acquirer processing systems have been cleared. In some embodiments, the acknowledgments are provided to the acquirer processing systems.

To settle the transaction, the processing system 1312 may send a message to the clearer processing system 1320 to direct the clearing processing system 1320 to perform fund transfers between issuer accounts and acquirer accounts, e.g., to withdraw funds out of the account of the issuer and to deposit o funds into the account of the acquirer. The clearer processing system 1320 may cause funds to be transferred between accounts that belong to the issuers and the acquirers.

The processing system 1312 may combine each transaction in a batch with other transactions bound for the same issuer, and may transmit the resulting batch of transactions to the clearer processing system 1320. The processing system 1312 and/or the clearer processing system 1320 may send the batch of transactions to the issuer processing system, e.g., issuer processing system 1316-1.

The issuer processing system may then charge each transaction to the corresponding payment card account for the cardholder who initiated the transaction. The clearing processing system 1320 may send an acknowledgement to the acquirer processing system for each transaction to indicate that the transaction has been cleared.

In some embodiments, the acquirer 104, the administrator 106 and the issuer 108 each receive compensation in association with the transaction. In some embodiments, the administrator 106 may charge a fee for each message sent to and/or from the administrator.

The acquirer processing system, e.g., acquirer processing system 1308-1, may send funds to, and/or cause funds to be deposited in an account of, the merchant. The amount of the funds may be equal to the amount of the purchase less the fees owed to the acquirer 104, the administrator 106 and the issuer 108.

In some embodiments, the clearance part of the transaction may be performed as soon as the message is received from the acquirer 104. In some other embodiments, the clearance part of the transaction may be performed as part of a batch. In some embodiments, a plurality of batches may be performed each day.

In some embodiments, the processing system 1312 may send all of the transaction data to the data warehouse 1326. The data warehouse 1326 may receive and store the transaction data to allow for subsequent audit of the transactions cleared through the system.

The rewards processing system 1330 may perform one or more portions of a rewards program. In some embodiments, the rewards processing system 1330 may perform one or more portions of one or more embodiments of one or more methods disclosed herein and/or one or more portions of one or more embodiments of a rewards program disclosed herein.

In that regard, in some embodiments, the rewards processing system 1330 may fetch purchase and/or other transaction data stored in the data warehouse 1326.

In some embodiments, the rewards processing system 1330 may also be coupled to the clearing processing system 1320 and/or the acquirer processing systems 1308-1 to 1308-m. In that regard, in some embodiments, the rewards processing system 1330 may supply data that is supplied to the clearing processing system 1320 and/or the acquirer processing systems 1308-1 to 1308-m.

FIG. 14 is a block diagram of one embodiment of the rewards processing system 1330 (FIG. 13). Referring to FIG. 14, in this embodiment, the rewards processing system 1330 includes a processor 1400 operatively coupled to a communication device 1402, an input device 1403, an output device 1404 and a storage device 1406. The communication device 1402 may be used to facilitate communication with other devices and/or systems, e.g., data warehouse 1330 (FIG. 13).

The input device 1403 may comprise, for example, one or more devices used to input data and information, such as, for example: a keyboard, a keypad, a mouse or other pointing device, a microphone, knob or a switch, an infra-red (IR) port, etc. The output device 1404 may comprise, for example, one or more devices used to output data and information, such as, for example: an IR port, a docking station, a display, a speaker, and/or a printer, etc. The storage device 1406 may comprise, for example, one or more storage devices, such as, for example, magnetic storage devices (e.g., magnetic tape and hard disk drives), optical storage devices, and/or semiconductor memory devices such as Random Access Memory (RAM) devices and Read Only Memory (ROM) devices.

The storage device 1406 may store one or more programs 1408, which may include one or more instructions to be executed by the processor 1400 to perform one or more portions of one or more embodiments of one or more rewards programs and/or one or more portions of one or more embodiments of one or more methods disclosed herein.

In some embodiments, one or more of the one or more programs 308 may include one or more criteria that may be used in carrying out one or more portions of one or more embodiments of one or more rewards programs and/or one or more portions of one or more embodiments of one or more methods disclosed herein.

In some embodiments, storage device 1408 may store one or more databases, including, for example, a rewards program database 1410, which may include criteria for one or more rewards programs, and/or an action database 1412, which may include one or more transactions and/or other actions for one or more customers, merchants and/or acquirers. In some embodiments, one or more of the databases may be used in carrying out one or more portions of one or more rewards programs and/or one or more portions of one or more embodiments of one or more methods disclosed herein.

Other programs and/or databases may also be employed.

As used herein a “database” may refer to one or more related or unrelated databases. Data may be stored in any form. In some embodiments, data may be stored in raw, excerpted, summarized and/or analyzed form.

Data may be received from any source(s). In some embodiments, the data may be received from one or more sources within the processing system 1330. In some embodiments, data may be received via the communication device 1402. In some embodiments, data may be received from the storage device 1406. In some embodiments, terms data may be supplied by a user via a user interface. In some embodiments, a user interface may comprise a graphical user interface. In some embodiments, the data may be received from one or more sources outside the processing system 1330. In some embodiments, the data may be receive from one or more sources within the processing system and one or more outside the processing system 1330. In some embodiments, data may be received from a combination of two or more of the above. In some embodiments, data may be received from one or more sources in lieu of and/or in addition to one or more of the sources described herein.

In some embodiments, the customer may supply one or more portions of the data via a website. If the customer is supplying one or more portions of the data via a website, the customer may employ a user interface. In some embodiments, a user interface may include a personal computer that executes a browser program, receives signals from one or more input devices, for example, a mouse and/or keyboard, supplies signals to one or more output devices, for example, a display, and forwards the personal information to the financial institution.

In some embodiments, one or more of the one or more databases may comprise a relational database or other type of database.

In some embodiments, processing system 1330 may be in communication with, or have access to, data from sources outside the rewards processing system (e.g., via communication device 1402).

In some embodiments, the one or more programs 1408 may include a program 1420 that may include one or more instructions to be executed by the processor 1400 to cause the rewards processing system to retrieve transaction data from the data warehouse 1326 (FIG. 13). The transaction data may include data that represents transactions cleared through the payment processing system 1300 (FIG. 13).

In some embodiments, the one or more programs 1408 may include a program 1422 that may include one or more instructions to be executed by the processor 1400 to cause the rewards processing system to identify transactions that qualify for one or more rewards under the one or more rewards programs administered by the rewards processing system.

In some embodiments, one or more of the one or more rewards programs 1408 and/or one or more portions of the rewards processing system may be administered by a payment card association that operates the payment processing network 1300.

In some embodiments, the one or more programs 1408 may include a program 1424 that may include one or more instructions to be executed by the processor 1400 to cause the rewards processing system to credit rewards to the accounts of customers that have performed one or more actions that qualify for rewards.

In some embodiments, the one or more programs 1408 may include a program 1426 that may include one or more instructions to be executed by the processor 1400 to cause the rewards processing system to generate data files to be transmitted to one or more acquirer processing systems 206-1 to 206-m and/or one or more merchant processing systems 1302-1 to 1302-n concerning rewards credited by the reward processing system 1330.

In some embodiments, the rewards processing system may include an operating system, a database management system, other applications, other data files, etc., for operation of the rewards processing system 1330.

In some embodiments, one or more of the other processing systems described herein may comprise a processing system having an architecture that is similar to embodiment of the processing system 1330 illustrated in FIG. 14.

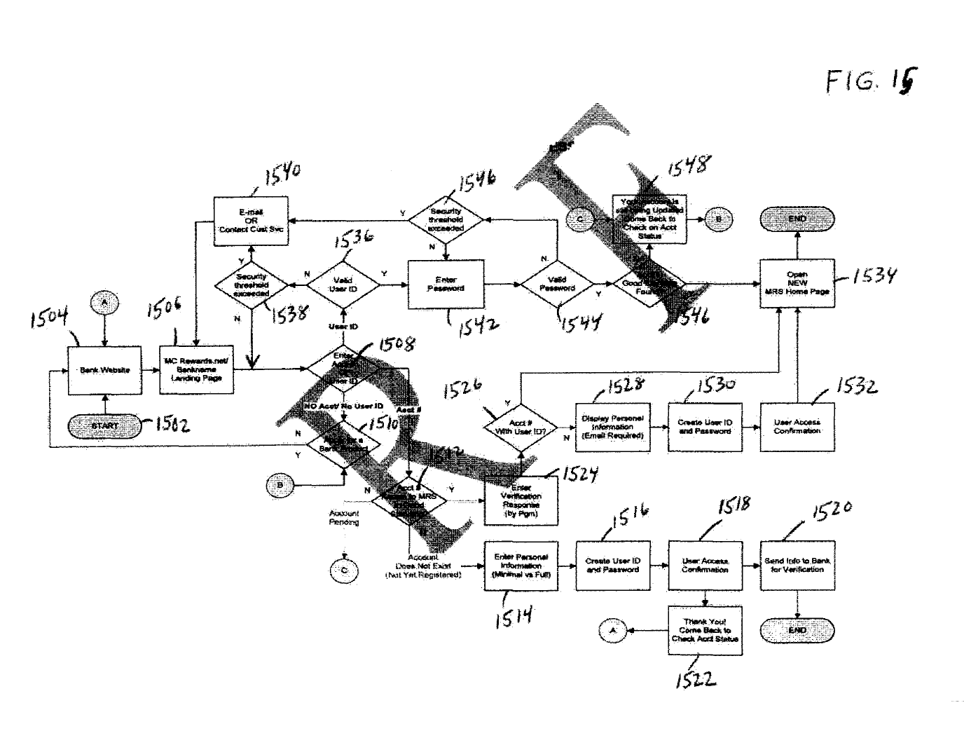

FIG. 15 is a flow chart of a method 1500 according to some embodiments. In some embodiments, one or more portions of the method may be performed by the processing system 1330 (FIG. 13). In some embodiments, one or more portions of the method may be used to enroll or add an account to a rewards program.

Referring to FIG. 15 the method may start at 1502. At 1504, a user may access a website of a bank or other provider. At 1502, the user may be sent to a landing page for a rewards program. At 1508, the user may be prompted to enter an account identifier or a user identifier. If the user does not enter an account identifier or a user identifier, then at 1510, the user may be asked whether the user desires to apply for a product of the bank or other provider and if so, at 1504, the user may be returned to the website of the bank or other provider.

If at 1508, the user enters an account number, then at 1512, a determination is made as to whether the account is known to the reward system and in good standing. If the account is not known to the reward system, then at 1514, the user may be prompted to enter personal information. At 1516, the user is prompted to create a user identifier and a password. At 1518, user access confirmation may be provided. At 1520, information may be sent to the bank or other provider for verification. At 1522, a “Thank You” message may be provided and the user may be invited to return to the website to check account status. Thereafter, at 1504, the user may be returned to the website of the bank or other provider.

If at 1512, the account is known to the reward system and the account is in good standing, then at 1524, a verification response may be provided by the program. At 1526, a determination may be made as to whether the account number has a user identifier. If the account number does not have a user identifier, then at 1528, personal information may be displayed. At 1530, the user may be prompted to create a user identifier and password. At 1532, user access confirmation may be provided. At 1534 the new reward system home page may be opened.

If at 1508, the user enters a user identifier, then at 1536, a determination is made as to whether the user identifier is valid. If the user identifier is not valid, then at 1538, a determination is made as to whether a security threshold is exceeded. If the security threshold is exceeded, then at 1540, the user is prompted to send an email or contact customer service.

If at 1538, the security threshold is not exceeded, then execution returns to 1508, and the user is again prompted to enter an account number of user identifier. If the user again enters a user identifier, execution returns to 1536 and a determination is made as to whether the user identifier is valid. If the user identifier is valid, then at 1542, the user may be prompted to enter a password.

At 1544, a determination may be made as to whether the password is valid. If the password is not valid, then at 1546, a determination is made as to whether a security threshold is exceeded. If the security threshold is exceeded, then at 1540, the user is prompted to send an email or contact customer service.

If at 1546, the security threshold is not exceeded, then execution returns to 1542, and the user is again prompted to enter a password. Execution returns to 1544 and a determination is made as to whether the password is valid. If the password is valid, then at 1546, a determination may be made as to whether one or more accounts of the user are found and in good standing. If one or more accounts are not found and in good standing, then at 1548, a message may be provided to inform the user that the user's account is still being updated. The user may be invited to return to the website to check on account status. At 1510, the user may be prompted to indicate whether the user desires to apply for a product of the bank or other provider. Execution may thereafter proceed as described above.

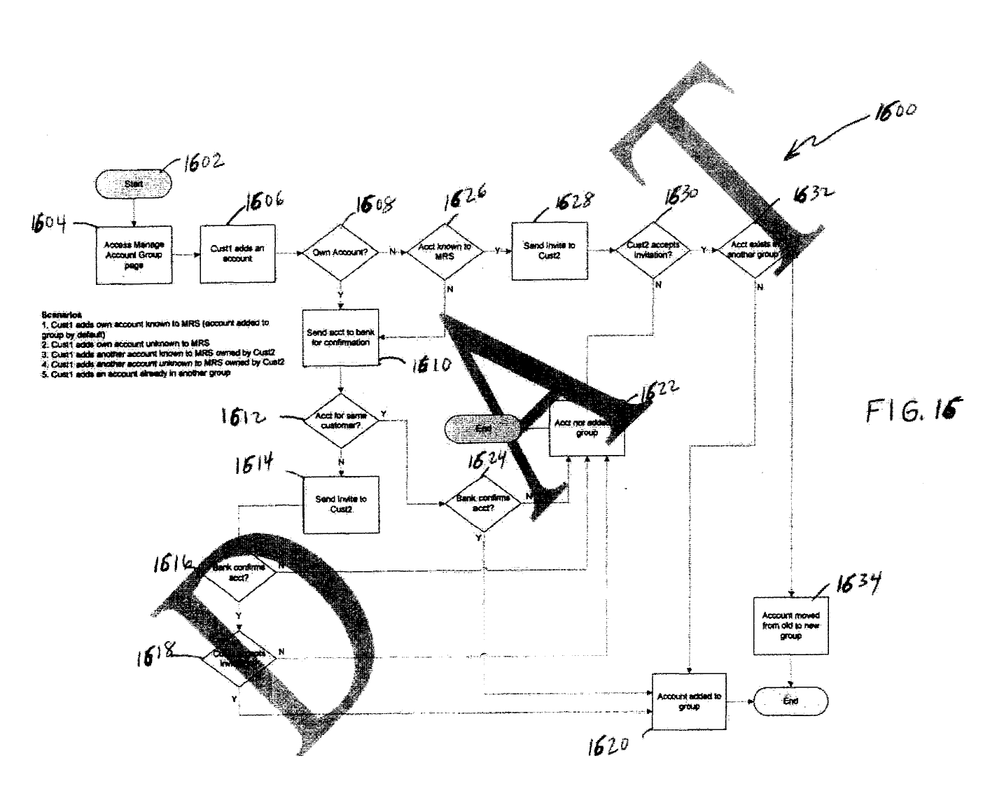

FIG. 16 is a flow chart of a method 1600 according to some embodiments. In some embodiments, one or more portions of the method may be performed by the processing system 1330 (FIG. 13). In some embodiments, one or more portions of the method may be used to enroll or add an account to a rewards program and/or to manage one or more groups of accounts enrolled in the rewards program.

Referring to FIG. 16 the method may start at 1602. At 1604, a user may access a manage account group page of a program for a website to provide web access to a reward program. At 1606, the user may add and/or enroll an account into the reward program. In some embodiments, the user may be prompted to supply an account identifier associated with the account to be added and/or enrolled. At 1608, the method may prompt the user to indicate whether the user owns the account. If the user owns the account, then at 1610, the account identifier associated with the account may be sent to a bank or other provider for confirmation.

At 1612, the method may prompt the user to indicate whether the account is for the same customer. If the account is not for the same customer, then at 1614, an invitation may be sent to a second customer. At 1616, a determination may be made as to whether the bank or other provider confirms the account. If the bank confirms the account, then at 1618, a determination may be made as to whether the second customer accepts the invitation. If the second customer accepts the invitation, then at 1620, the account is added to the group. If the second customer does not accept the invitation, then at 1622, the account is not added to the group.

At 1612, if the account is for the same customer, then at 1624, a determination may be made as to whether the bank or other provider confirms the account. If the bank or other provider confirms the account, then at 1620, the account is added to the group. If the bank or other provider does not confirm the account, then at 1622, the account is not added to the group.

At 1608, if the user does not own the account, then at 1626, a determination may be made as to whether the account is known to the MRS or other system. If the account is not known to the reward system, then then at 1610, the account identifier associated with the account may be sent to a bank or other provider for confirmation. Thereafter, execution may proceed to 1612 and may proceed as described above.

If at 1626, the account is know to the reward system, then at 1628, an invitation may be sent to a second customer. At 1630, a determination may be made as to whether the second customer accepts the invitation. If the second customer does not accept the invitation, then at 1622, the account is not added to the group. If the second customer accepts the invitation, then at 1633, a determination may be made as to whether the account exits in another group. If the account does not exist in another group, then at 1620, the account is added to the group. If the account does exist in another group, then at 1634, the account is moved from the old group to the new group.

Reference is now made to FIG. 17, where a flow chart of a method 1700 is shown pursuant to some embodiments. Method 1700 is a method for distributing rewards based on one or more automatic redemption rules. Pursuant to some embodiments, as discussed above, customers (or other entities) may establish one or more reward redemption rules which are automatically applied by a system such as the rewards administrator 16 of FIG. 1. For example, in some embodiments, a customer may log onto a Website, IVR, or other system and establish redemption rules associated with a rewards account held by the customer. As a specific example, a customer participating in a relationship rewards program pursuant to the present invention may specify automatic redemption rules for an account or an account group. An automatic redemption rule may include identification of the customer and the reward account to which it applies as well as one or more conditions which will trigger the distribution of a reward and the specific reward to be redeemed. As an illustrative example, a customer (“John Doe”) may establish an automatic redemption rule for a reward account in which $25 Savings Bonds will be purchased using reward points each time John Doe's reward account reaches a balance sufficient to purchase a $25 Savings Bond. Other redemption rules and conditions may also be specified.

The process 1700 of FIG. 17 is a process operated by, for example, a rewards administrator such as the rewards administrator 16 of FIG. 1. That is, the process operates on rules previously established by customers or other entities. Referring to FIG. 17, the automatic redemption rule process 1700 may begin at 1702 where transactions associated with participating customers are analyzed to identify any reward-eligible transactions. Processing continues at 1704 where reward amounts are calculated for each of the reward-eligible transactions associated with each participating customer. This may involve, for example, applying one or more reward rules established by reward program participants or providers. At 1706, the customer's reward balance is updated to reflect the reward amounts calculated at 1704. At 1708 any automatic redemption rules associated with the customer are applied to the customer's reward balance. For example, if an automatic redemption rule indicates that once the customer's reward balance reaches 10,000 points and the customer's reward account, based on the update at 1706, has reached or exceeded 10,000 points, the automatic redemption rule will be triggered. Processing at 1708 includes applying the terms of the triggered rule. For example, if the triggered rule identifies that, upon reaching 10,000 points, the customer wishes to redeem the points by purchasing a $25 Savings Bond, then at 1708 the action will be taken.

Processing continues at 1710 where the reward is distributed based on the automatic redemption rule. Put another way, at 1710, processing includes redeeming the reward based on the automatic redemption rule. In the example, the $25 Savings Bond is purchased for the customer and the customer's reward account balance is reduced accordingly. The process 1700 may be performed in real time or on a batch basis (e.g., as a nightly process) so that automatic redemption rules are applied frequently. In this manner, customers enjoy greater control and use of their reward balances. Those skilled in the art will appreciate that the automatic redemption process of FIG. 17 may be utilized in a number of different types of reward programs, not just the relationship reward program discussed herein.

In some embodiments, one or more portions of one or more methods and/or systems disclosed herein may employ one or more portions of a pre-existing payment processing network. In that regard, in some embodiments, processing and/or administrative economies may be realized by using one or more portions of a previously existing payment processing network.

In some other embodiments, the methods and/or systems disclosed herein without any portion of a pre-existing payment processing network.

In some embodiments, one or more of the methods and/or systems disclosed herein may encourage one or more customers to have more than one accounts with a provider. In some embodiments, this may have the advantage of increasing profit of the provider.

In some embodiments, one or more of the processing systems are integrated into a single processing system.

In some embodiments, a rewards system may include one or more websites. In some embodiments, the website(s) may be used for enrollment, account registration and management, program maintenance, statements or other types of reports, vendor management customer service and/or billing in association with one or more rewards programs available from one or more providers.

Unless otherwise stated, terms such as, for example, “in response to” and “based on” mean “in response at least to” and “based at least on”, respectively, so as not to preclude being responsive to and/or based on, more than one thing.

In addition, unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively. Moreover, unless stated otherwise, the term “first” does not, by itself, require that there also be a “second”.

Although various features, attributes and/or advantages may be described herein and/or may be apparent in light of the description herein, it should be understood that unless stated otherwise, such features, attributes and/or advantages are not required and need not be present in all aspects and/or embodiments.

While various embodiments have been described, such description should not be interpreted in a limiting sense. It is to be understood that modifications of such embodiments, as well as additional embodiments, may be utilized without departing from the spirit and scope of the invention, as recited in the claims appended hereto.

What is claimed is:

1. A method comprising:
receiving data indicative of a plurality of relationships between a customer and a provider and maintained by the provider;
associating the data indicative of a plurality of relationships with a unique customer identifier assigned to the customer;
receiving data indicative of a first action performed by the customer in association with a first one of the plurality of relationships;
receiving data indicative of a second action performed by the customer in association with a second one of the plurality of relationships;
determining a first reward for the first action performed by the customer in association with the first one of the plurality of relationships;
determining a second reward for the second action performed by the customer in association with the second one of the plurality of relationships; and
aggregating the first reward and the second reward.

2. The method of claim 1, further comprising:
receiving data indicative of a second plurality of relationships between the customer and a second provider and maintained by the second provider; and
associating the data indicative of a second plurality of relationships with the unique customer identifier assigned to the customer.

3. The method of claim 2, further comprising:
receiving data indicative of a third action performed by the customer in association with one of the second plurality of relationships;
determining a third reward for the third action performed by the customer in association with one of the second plurality of relationships; and
aggregating the first reward, the second reward, and the third reward.

4. The method of claim 1, where at least one of the plurality of relationships between the customer and the provider are not previously associated with any other of the plurality of relationships.

5. The method of claim 1, wherein the determining a first reward is performed by at least one of the provider and a rewards administrator.

6. The method of claim 1, wherein the determining a second reward is performed by at least one of the provider and a rewards administrator.

7. The method of claim 1, wherein at least one of the first action and the second action comprises a purchase.

8. The method of claim 1, further comprising:
receiving, from the customer, a request to aggregate rewards from a selected group of the plurality of relationships.

9. The method of claim 8, further comprising:
receiving an identifier for the group.

10. The method of claim 1, wherein determining a first reward for the first action performed by the customer comprises:
determining whether the first action performed by the customer in association with the first one of the plurality of relationships qualifies for a reward; and
determining the first reward if the action performed by the customer in association with the first one of the plurality of relationships qualifies for a reward.

11. The method of claim 1, wherein determining a first reward for the first action performed by the customer comprises:
determining a first reward for the first action performed by the customer in association with the first one of the plurality of relationships based at least in part on data indicative of the action performed by the customer in association with the first one of the plurality of relationships and data that defines a reward program for which the first relationship is eligible.

12. The method of claim 1, further comprising receiving data indicating how at least one portion of at least one of the first reward and the second reward is to be redeemed.

13. The method of claim 12, wherein the data indicating how at least a portion of at least one of the first reward and the second reward is to be redeemed comprises:
at least one automatic redemption trigger.

14. The method of claim 13, wherein the at least one automatic redemption trigger comprises:
at least one automatic redemption trigger specified by the customer.

15. The method of claim 1, further comprising:
receiving data indicative of at least one relationship between a second customer and a provider;
associating the data indicative of at least one relationship between the second customer and a provider with the unique customer identifier assigned to the customer;
receiving data indicative of an action performed by the second customer in association with the at least one relationship of the second customer;
determining a reward for the action performed by the second customer; and
aggregating the first reward for the first action performed by the customer, the second reward for the second action performed by the customer and the reward for the action performed by the second customer.

16. The method of claim 1, further comprising:
receiving a request from a second customer to designate an relationship to group with the relationships of the first customer.

17. The method of claim 1, further comprising:
receiving a request from the customer to invite a second customer to designate a relationship to group with the relationships of the customer.

18. The method of claim 15, wherein the provider associated with the second customer is different than the provider associated with the customer.

19. A method for processing reward transactions associated with a customer, the method comprising:
identifying transactions associated with the customer;
calculating reward amounts associated with the transactions;
updating a reward balance in a reward account associated with the customer;
applying at least a first automatic redemption rule established by the customer to the reward balance; and
distributing at least a portion of the reward balance based on the at least first automatic redemption rule.

20. An apparatus, comprising:
a memory storing processor-executable process steps; and
a processor in communication with the memory and operative in conjunction with the stored process steps to:
receive data indicative of a plurality of relationships between a customer and a provider and maintained by the provider;
associate the data indicative of a plurality of relationships with a unique customer identifier assigned to the customer;
receive data indicative of at least a first and a second action performed by the customer in association with at least one of the plurality of relationships;
determine a reward amount for each of the at least first and second actions;
aggregating the reward amounts; and
updating a reward account associated with said customer to reflect the aggregated reward amounts.
